(19) United States
(12) Patent Application Publication
(10) Pub. No.: US 2026/0132021 A1
(43) Pub. Date: May 14, 2026

(54) AMMONIA REACTOR AND METHODS

(71) Applicant: United Kingdom Research and Innovation, Swindon Wiltshire (GB)

(72) Inventors: Richard Cowan, Oxforshire (GB); Benjamin Matthew Peters, Oxfordshire (GB); Tristan Davenne, Oxfordshire (GB); Adam Huddart, Oxfordshire (GB); Dominique Tallentire, Oxfordshire (GB)

(73) Assignee: United Kingdom Research and Innovation, Swindon Wiltshire (GB)

(21) Appl. No.: 19/118,652

(22) PCT Filed: Sep. 12, 2023
(86) PCT No.: PCT/EP2023/075019

§ 371 Date: Apr. 4, 2025

(30) Foreign Application Priority Data
Oct. 6, 2022 (GB) 2214677.3
Jul. 6, 2023 (GB) 2310413.6

(51) Int. Cl. C01B 3/025; B01J 8/04; B01J 8/06

(52) U.S. Cl. CPC C01B 3/025; B01J 8/0411; B01J 8/0492; B01J 8/067; B01J 2208/00203; B01J 2208/00495; B01J 2208/0053; C01B 2203/068; C01B 2203/0844; C01B 2203/0872

(57) ABSTRACT

There is described a reactor for generating ammonia from a synthesis gas by an exothermic reaction. The reactor comprises: a reactor vessel having a first inlet and one or more second inlets for receiving the synthesis gas, the reactor vessel configured as a quench cooled reactor having a plurality of reactor segments, the one or more second inlets being quench inlets, the reactor vessel having a base region with one or more exit ports configured to output synthesis gas and ammonia gas received from the reactor segments; a first heat exchanger coupled between the first inlet and the base region for transferring heat between the output gases and synthesis gas flowing to the first inlet; a reverse bypass configured to receive output gases from one of the one or more exit ports and bypass the first heat exchanger; and a control system configured to selectively control the flow of output gases through the first heat exchanger and reverse bypass. There are also described methods of generating ammonia from a synthesis gas by exothermic reaction. There is further described an energy storage system and a controller.

The present disclosure relates to a reactors and methods for generating ammonia from a synthesis gas. The present disclosure also provides an energy storage system comprising one or more intermittent sources of renewable energy for producing the synthesis gas and the reactor for generating the ammonia.

### INTRODUCTION

In recent years the deployment of renewable energy sources such as wind turbines and solar panels has increased with the aim of delivering cleaner, low-carbon electricity. A difficulty with many renewable sources of energy is that they do not provide a continuous flow of energy and that energy is not supplied at a constant rate. For example, sometimes the wind does not blow or blows at different speeds which may result in no electricity or a variation in the amount of electricity produced. In times of low wind, or no wind, the electricity supplied has to be made up from other sources, such as carbon intensive fossil fuel sources or nuclear power. In times of high wind or low electricity demand the amount of electricity supplied from wind turbines may exceed demand so it would be desirable to store the excess electricity for later times when there is a shortfall in supply. Similar considerations apply for solar power, because the sun does not shine at night and does not shine evenly all year round.

FIG. 1 is a schematic diagram showing two renewable energy sources 10, 20, connected to a national power grid or network 30. The national power grid or network 30 supplies electricity to households and businesses across a country. The renewable energy sources 10, 20, may be wind turbines or solar panels. Alternatively, they could be other renewable energy sources such as hydropower or tidal energy sources. All of these sources are intermittent sources. The renewable energy sources are coupled to the national power grid by transformers 14, 24. For times when surplus electricity is able to be supplied, the renewable energy sources may be coupled to energy stores 12, 22, for example, electricity storage devices such as batteries. However, electricity storage on large scales is difficult.

Efforts have been made to develop technologies to harness the unused electricity and to supply electricity when renewable sources are not generating such as when the wind is not blowing. One option that has been considered is to generate hydrogen from the surplus electricity but it is difficult to store because high pressures and very low temperatures are required. The hydrogen can be used to generate electricity or be used for powering vehicles or heating.

Ammonia is another option being considered as a way of storing energy. Ammonia is easier to store than hydrogen because the pressures and temperatures required are not so demanding as for hydrogen. When burned, ammonia produces nitrogen and water and does not produce carbon dioxide. Ammonia is also a significant component in the production of fertilizers. By conventional means, ammonia production for fertilizers releases over 1.5% of global carbon dioxide emissions.

Ammonia produced from unused renewable energy sources is often called green ammonia. However, current technologies do not fully address and are not designed for the intermittency and variability of renewable energy sources, or if they are they fall-back to using electricity from the grid which may not be from low carbon or renewable sources.

Accordingly, it would be desirable to address problems and limitations of the prior art.

### SUMMARY OF THE INVENTION

The invention provides a reactor for generating ammonia from a synthesis gas by an exothermic reaction. The reactor for generating ammonia may be used to convert hydrogen obtained from intermittent or variable output renewable energy sources such as wind turbines and solar panels. This avoids the need to accommodate the variability by use of hydrogen storage tanks, which are difficult and costly, or battery energy storage, which may be inflexible. The reactor may avoid curtailment of renewable energy sources by being agile in the generation rate of ammonia and ability to start or restart rapidly. The present invention may also provide a reactor for generating a product from a synthesis gas by an exothermic reaction.

Embodiments of the present invention provide a reactor for generating ammonia from a synthesis gas by an exothermic reaction, the reactor comprising: a reactor vessel having a first inlet and one or more second inlets for receiving the synthesis gas, the reactor vessel configured as a quench cooled reactor having a plurality of reactor segments, the one or more second inlets being quench inlets, the reactor vessel having a base region with one or more exit ports configured to output synthesis gas and ammonia gas received from, or that has passed through, the reactor segments; a first heat exchanger coupled between the first inlet and the base region for transferring heat between the output gases and synthesis gas flowing to the first inlet; a reverse bypass configured to receive output gases from one of the one or more exit ports and bypass the heat exchanger and a control system configured to selectively control the flow of output gases through the heat exchanger and reverse bypass. The base region may be a region or space below the reactor segments. The reverse bypass may cause the output gases to bypass the heat exchanger and be passed to an output or recycle loop which separates the synthesis gas from ammonia gas product.

The control system may be configured to selectively control the flow of output gases through the first heat exchanger and reverse bypass by opening reverse bypass to increase heat removal from the output gases.

The reactor may further comprise a thermal store arranged to selectively receive heat from the output gases. The reactor may further comprise a second heat exchanger along with the thermal store, the second heat exchanger is a thermal store heat exchanger and may be configured to selectively receive output gases and transfer heat between the output gases and the thermal store via a heat transfer fluid. By transfer between, heat may be supplied from the output gases to the thermal store.

The thermal store heat exchanger may be connected to the reverse bypass to receive output gases when the control system selects flow through the reverse bypass.

The thermal store may be a stratified heat store having a hot end into which heat from the output gases is directed using the heat transfer fluid.

The reactor may further comprise a regenerative ammonia absorber, such as MgCl₂, arranged to receive heat from the thermal store to regenerate the ammonia absorber.

The reactor may further comprise a forward bypass configured for receiving synthesis gas, bypassing the first heat exchanger and flowing synthesis gas to the first inlet. The synthesis gas received may be from a source, buffer or reservoir.

The control system may be configured to selectively control the flow of synthesis gas through the first heat exchanger and forward bypass to control the temperature of the synthesis gas at the first inlet.

The quench cooled reactor may be an adiabatic quench cooled reactor. The reactor segments are preferably arranged in series.

The plurality of reactor segments may each comprise a reaction volume which contains a catalyst for the exothermic reaction. The plurality of reactor segments are preferably arranged sequentially such that the synthesis gas received at the first inlet flows through each of the plurality of reactor segments in turn. Second inlets are preferably arranged between reactor segments for supplying further synthesis gas for subsequent reactor segments.

The control system may be configured to control the amount of synthesis gas supplied to the quench inlets to control the temperature in the subsequent reactor segment. The control system may be configured to increase the amount of synthesis gas added at second inlets to decrease the temperature in the reactor segment following the second inlet.

The reactor segments may be sized with increasing reaction volumes from the first inlet. For example, three reactor segments may have reaction volumes increasing in size in the ratios 1 to 2 to 5 or more, such as around 1:2:6 or 1:2:7.

The control system may be configured to control the flow of synthesis gas to the reactor segments to vary the ammonia generation rate between a minimum generation rate and a maximum generation rate which may have a ratio of 1:5 or more, such as 1:7 or more preferably 1:9.

The control system may be configured to control the flow rate of synthesis gas into the first inlet and to stop, or reduce, the flow of synthesis gas into the second inlets at the minimum generation rate such that the exothermic reaction substantially occurs, that is the majority of the reaction occurs, in a first reactor segment, for example the reactor segment closest to the first inlet and/or the reactor segment having the smallest reaction volume. The minimum generation rate may be the minimum rate of ammonia generation that is achieved stably.

The control system may be further configured to control the flow rate of synthesis gas into the first inlet and second inlets at a reaction rate greater than the minimum generation rate such that the exothermic reaction occurs in reactor segments in addition to the first reactor segment.

The control system may be further configured to control the flow rate of synthesis gas into the first inlet and into the second inlets at the maximum generation rate, such that the exothermic reaction is spread substantially through each of the plurality of reactor segments, for example, substantially evenly across all reactor segments.

The control system may be further configured to stop the flow of synthesis gas into the first and second inlets in a pilot mode, and the reactor is arranged with a first reactor segment above subsequent reactor segments such that heat from second and subsequent reactor segments rises to maintain a minimum generation temperature in the first reactor segment.

The reactor segments are preferably stacked vertically and the first inlet is arranged to supply the synthesis gas to the uppermost reactor segment. The reactor may comprise a flow tube passing inside the reactor vessel from the base region upwards through the reactor segments and may be configured to flow synthesis gas and ammonia therethrough. The flow tube may be coupled to the first heat exchanger to flow synthesis gas and ammonia gas to heat the first heat exchanger.

The first heat exchanger may comprise an auxiliary heater, such as an electrical heater, for heating synthesis gas passing to the first inlet, such as on start-up of ammonia generation.

The reactor vessel and first heat exchanger may be insulated by encasing together in a surrounding shell or enclosure of insulation.

Between adjacent reactor segments may be a mixing zone for receiving flow from quench inlets and mixing the synthesis gas flow with flow of synthesis gas and ammonia gas from a preceding reactor segment. The mixing zone may comprise a neck portion having a narrower flow area than the flow area of the reactor segments. By flow area it is understood to mean flow cross-section.

The efficacy of the catalyst in the pilot segment may be less than in other reactor segments. By efficacy we less effect per unit volume of the reactor segment.

The synthesis gas preferably comprises hydrogen and nitrogen.

Embodiments of the present invention further provide an energy storage system comprising: one or more intermittent sources of renewable energy; an electrolysis unit for producing hydrogen using the renewable energy; and any of the reactors set out herein arranged to generate ammonia from the produced hydrogen. The one or more intermittent sources of renewable energy may comprise one or more wind turbines, and/or one or more solar panels.

Embodiments of the present invention provide a method of generating ammonia from a synthesis gas by an exothermic reaction, the method comprising: flowing the synthesis gas into a first inlet of a reactor vessel to pass through a plurality of reactor segments to a base region of the reactor vessel, wherein in one or more of the reactor segments synthesis gas reacts exothermally to generate ammonia gas; transferring heat, via a first heat exchanger, between the synthesis gas flowing to the first inlet and output gases comprising the ammonia gas and synthesis gas flowing from the base region; and selectively opening a reverse bypass to receive a portion of output gases from the base region and bypass the first heat exchanger. Selectively opening the reverse bypass may increase the heat removal form the output gases.

The method may further comprise flowing the portion of the output gases received from the base region through the reverse bypass to a second heat exchanger to transfer heat from the portion of the output gases to a thermal store via a heat transfer fluid.

The method may further comprise selectively opening a forward bypass for receiving a portion of synthesis gas, flowing the portion of synthesis gas through a forward bypass, bypassing the first heat exchanger and flowing the portion of synthesis gas to the first inlet.

Selectively opening the forward bypass and flowing the portion of synthesis gas therethrough controls or reduces the temperature of the synthesis at the first inlet.

Flowing the synthesis gas through a plurality of reactor segments may comprise flowing the synthesis gas sequentially through a catalyst for the exothermic reaction in each of the plurality of reactor segments, and further comprising selectively supplying further synthesis gas to the reactor vessel at second inlets between reactor segments. The supply of further synthesis gas at the second or quench inlets is to cool down the reaction to prevent the catalyst temperature becoming too high such that yield drops.

The reactor segments may be sized with increasing reaction volumes from the first inlet, and the method may comprise controlling the flow of synthesis gas to the reactor segments to vary the ammonia generation rate between a minimum generation rate and a maximum generation rate which have a ratio of 1:5 or more, such as 1:7 or 1:9 etc.

The method may further comprise controlling the flow rate of synthesis gas into the first inlet and second inlets at the minimum generation rate such that the exothermic reaction substantially occurs, that is the majority of it occurs, in a first reactor segment closest to the first inlet.

The method may further comprise controlling the flow rate of synthesis gas into the first inlet and second inlets at a reaction rate greater than the minimum generation rate such that the exothermic reaction occurs in reactor segments in addition to the first reactor segment.

The method may further comprise controlling the flow rate of synthesis gas into the first inlet and into the second inlets at a generation rate at a maximum generation rate such that the exothermic reaction is spread substantially through each of the plurality of reactor segments.

The method may further comprise stopping the flow of synthesis gas into the first and second inlets in a pilot mode, and heat from second and subsequent reactor segments rises to maintain a minimum generation temperature in the first reactor segment.

The method may further comprise mixing, at a mixing zone between adjacent reactor segments, a flow of synthesis gas received from a quench inlet with the flow of synthesis gas and ammonia gas from a preceding reactor segment.

Embodiments provide a method of generating ammonia comprising: generating electricity using one or more intermittent sources of renewable energy; using the renewable energy to produce hydrogen by electrolysis of water; and generating, by a variable generation rate reactor, ammonia from the produced hydrogen.

The method may further comprise storing the generated electricity in a buffer electricity store and supplying electricity from the buffer store to an electrolyser to produce the hydrogen.

The buffer electricity store may be a battery store.

The method may further comprise controlling the electricity supplied to, or the operating point of, the electrolyser to target a set-point proportion, or a target range, of full charge of the buffer electricity store. In other words, the set-point proportion may be a particular fraction or percentage of full charge, and a target range may be a range of fractions or percentage of full charge, such as 40-60%.

The set-point proportion may be 50% of full charge.

The method may further comprise increasing hydrogen generation by the electrolyser when the charged stored in the buffer electricity store exceeds the target or target range.

The method may further comprise decreasing hydrogen generation by the electrolyser when the charged stored in the buffer electricity store falls below the target or target range.

The method may further comprise storing the generated hydrogen in a buffer pressure vessel and supplying hydrogen from the buffer pressure vessel to the reactor to generate ammonia.

The method may further comprise controlling hydrogen supply to the reactor to target a set point proportion, or a target range, of full capacity of the buffer pressure vessel.

The method may further comprise increasing hydrogen supply to the reactor when the hydrogen pressure in the buffer pressure vessel exceeds the target or target range.

The method may further comprise decreasing hydrogen supply to the reactor when hydrogen pressure in the buffer pressure vessel falls below the target or target range.

The set point proportion of full capacity of the pressure vessel may be 50% of full capacity.

Embodiments further provide a controller for controlling an ammonia generation method, the ammonia generation method comprising: generating electricity using one or more intermittent sources of renewable energy; storing the generated electricity in a buffer store and supplying electricity from the buffer store to an electrolyser; using the stored electricity to produce hydrogen by electrolysis of water by the electrolyser; storing the produced hydrogen in a buffer pressure vessel, and generating, by a variable generation rate reactor, ammonia from the produced hydrogen, wherein the controller is configured to control the supply of electricity to the electrolyser and control the supply of hydrogen to the reactor.

The controller may be configured to control the electricity supplied to, or the operating point of, the electrolyser to target a set point proportion, or a target range, of full charge of the buffer electricity store. The set point proportion may be 50% of full charge.

The controller may be configured to increase hydrogen generation by the electrolyser when the charged stored in the buffer electricity store exceeds the target or target range.

The controller may be configured to decrease hydrogen generation by the electrolyser when the charged stored in the buffer electricity store falls below the target or target range.

The controller may be configured to control hydrogen supply to the reactor to target a set point proportion, or a target range, of full capacity of the buffer pressure vessel.

The controller may be configured to increase hydrogen supply to the reactor when the hydrogen pressure in the buffer pressure vessel exceeds the target or target range.

The controller may be configured to decrease hydrogen supply to the reactor when hydrogen pressure in the buffer pressure vessel falls below the target or target range.

The set point proportion of full capacity of the pressure vessel may be 50% of full capacity.

The method of generating ammonia set out above or the controller set out above may include any of the reactors set out herein.

The present disclosure provides a reactor for generating ammonia from a synthesis gas by an exothermic reaction, comprising: a reactor vessel having a first inlet and one or more second inlets for receiving the synthesis gas, the reactor vessel configured as a quench cooled reactor having a plurality of reactor segments, the one or more second inlets being quench inlets, the reactor vessel having a base region with one or more exit ports configured to output synthesis gas and ammonia gas received from the reactor segments; a first heat exchanger coupled between the first inlet and the base region for transferring heat between the output gases and synthesis gas flowing to the first inlet; a forward bypass configured for receiving synthesis gas, bypassing the first heat exchanger and flowing the synthesis gas to the first inlet; and a control system configured to selectively control the flow of output gases through the first heat exchanger and forward bypass.

The present disclosure further provides a method of generating ammonia from a synthesis gas by an exothermic reaction, the method comprising: flowing the synthesis gas into a first inlet of a reactor vessel to pass through a plurality of reactor segments to a base region of the reactor vessel, wherein in one or more of the reactor segments synthesis gas reacts exothermally to generate ammonia gas; transferring heat, via a first heat exchanger, between the synthesis gas flowing to the first inlet and output gases comprising the ammonia gas and synthesis gas flowing from the base region, and selectively opening a forward bypass to receive a portion of the synthesis gas. bypass the first heat exchanger and flowing the synthesis gas to the first inlet.

The present disclosure provides a reactor vessel having a first inlet and one or more second inlets for receiving synthesis gas, the reactor vessel configured as a quench cooled reactor having a plurality of reactor segments, the one or more second inlets being quench inlets, wherein between adjacent reactor segments is a mixing zone for receiving gas flow from quench inlets and mixing the gas flow with flow of synthesis gas and products from a preceding reactor segment, wherein the mixing zone comprises a neck portion having a narrower flow cross-section than the flow cross-section of the reactor segments.

Embodiments further provide an alternative reactor to that set out above, as we will now describe. A reactor for generating ammonia from a synthesis gas by an exothermic reaction comprises: a plurality of reactor modules each comprising a reaction volume which contains a catalyst for the exothermic reaction and which is arranged to a receive the synthesis gas, and a heat transfer volume arranged to receive heat transfer fluid for delivering heat to or receiving heat from the reaction volume. Each reactor module is arranged to be in a production state in which the ammonia is being generated or an idle state in which it is not being generated. The reactor further comprises: a heat store coupled to each of the reactor modules so as to controllably receive the heat transfer fluid from, or deliver the heat transfer fluid to, any of the reactor modules; and a control system arranged to selectively transfer heat, by controlled flow of the heat transfer fluid, from one or more of the reactor modules which are in the production state, to the heat store, and to selectively transfer heat, by controlled flow of the heat transfer fluid, from the heat store, to one or more of the reactor modules which are in the idle state. The heat store may provide the ability for the ammonia generator to rapidly restart, such as when needed depending on renewable energy production.

The control system may be arranged to selectively transfer heat, by controlled flow of the heat transfer fluid, from one or more of the reactor modules which are in the production state, directly to one or more of the reactor modules which are in the idle state. That is, the heat may be transferred from one or more production reactor modules to one or more idle reactor modules without first passing through the heat store. This transfer of heat between modules may allow rapid increase or decrease in ammonia generation rates by having another reactor module, which may have a differently sized reaction volume, to be ready to start producing ammonia almost instantly.

The heat from the exothermic reaction may be used to maintain heated and ready for rapid start-up other reactor modules and/or the excess heat from the reaction may be stored in a heat store for use later.

At least a portion of the reaction volume is preferably at, or above, a minimum production temperature for a reactor module to be in the production state, and the control system is preferably arranged to maintain one or more, or all, of the reactor modules which are in the idle state at or above the minimum production temperature by transfer of heat using the heat transfer fluid, from the heat store and/or from one or more of the reaction modules which are in the production state. The minimum production temperature may be the temperature at which the production of ammonia is stably and/or efficiently maintained. For example, the minimum production temperature may be reached across sufficient of the reaction volume that the reaction is sustained and not quenched.

Each reactor module may be arranged to be in a shutdown state if not in a production state and not in an idle state. The shutdown state may be where all of the said reaction volume is below the minimum production temperature, for example, such that the reaction is not sustained and the reaction is quenched. The control system may be arranged to raise the temperature of at least a portion of said reaction volume to at least the minimum production temperature using the heat transfer fluid to transfer heat from the heat store or from one or more other ones of the reaction modules which are in the production state. When a reactor module is transitioned quickly from the shutdown state to the idle state and on to a production state, it is possible that not all of the reaction volume will fully equalise to the minimum production temperature or activation temperature before production is attempted. The heat of the exothermic reaction may be used to increase and equalise the temperature through the reactor module.

The control system may be arranged to transition any of the reactor modules from the idle state to the production state, including by introducing a production flow of the synthesis gas through, or into, the reaction volume of the reactor module in the idle state.

The control system may be arranged to control the flow of heat transfer fluid such that if one or more of the reactor modules are in the production state, the heat transfer fluid from the one or more reactor modules is directed to supply heat to the heat store.

The reactor may further comprise a separator arranged to receive the synthesis gas following flow through at least the reactor modules currently in the production state, to separate ammonia from the received synthesis gas, and to return the synthesis gas to at least the reactor modules currently in the production state.

The reactor may further comprise a recuperative heat exchanger arranged to transfer heat from the synthesis gas flowing from the reactor modules to the separator, to the synthesis gas flowing from the separator to the reactor modules. This may prevent or help to maintain heat being lost from the reactor modules when the synthesis gas leaves the reactor modules.

The reactor may be arranged to maintain the reaction volume of each reactor module above a minimum reaction pressure, and to maintain the heat transfer volume of each reactor module below a maximum heat transfer fluid pressure. The minimum reaction pressure may be at least twice the maximum heat transfer fluid pressure. The lower pressure of the heat transfer volume and flow circuit makes the thermal management easier and allows a heat store to be provided that does not require high pressures.

The minimum reaction pressure may be at least 20 bar, or at least 50 bar, and the maximum heat transfer pressure may be no more than 10 bar, or no more than 2 bar.

The reaction volume of each reactor module may be defined by a plurality of reaction tubes each containing said catalyst. The reaction tubes may be arranged to carry in parallel synthesis gas flowing through the reaction volume.

The heat transfer volume of each reactor module may be defined by a vessel containing the reaction volume. The heat transfer fluid may be a gas such as a relatively inert gas, for example, nitrogen.

The reaction volume of a smaller one of the reactor modules may be no more than 50% of the reaction volume of a larger one of the reactor modules.

Each of the reactor modules may have a minimum and a maximum rate of generation of the ammonia when in the production state, and the maximum rate of ammonia generation of a smaller one of the reactor modules may exceed the minimum rate of ammonia generation of a larger one of the production modules.

The ratio of maximum to minimum rate of generation of the ammonia, of each of the reactor modules is no more than twenty, no more than ten, no more than five, or no more than thee. The ratio of maximum to minimum rate of generation may be known as the turn-down ratio. The more modules and/or greater turn-down ratio provide greater agility in the amount of ammonia that may be produced and the amount of surplus renewable energy that may be consumed. Hence, curtailment of use of renewable energy may be minimised.

The reactor may be arranged such that in the production state the reaction volumes operate in a flow through mode with the synthesis gas flowing through, or the reaction volumes operate in a batch mode. In batch mode the reaction volume may be filled with synthesis gas and no further synthesis gas is added until a reaction period has completed.

The controller may be arranged to direct the heat transfer fluid through each reactor module only in the same direction as the flow of synthesis gas through the reactor module. The direction of flow of heat transfer fluid and synthesis gas through the reactor module may be upwards. By having the same flow direction, heating at the entry end is maximised (from the combination of the exothermic reaction and heat transfer fluid). By having upwards flow the heat from the reaction may be used to heat the rest of the reaction volume.

The heat store may be a stratified heat store. The heat store may have a hot end into which heat from the reactor modules is directed using the heat transfer fluid, and from which heat from the heat store is directed to the reactor modules using the heat transfer fluid. This approach uses the hot end to maximise the temperature of heat transfer.

The reactor may further comprise an excess heat exchanger arranged to remove heat from the heat transfer fluid if the heat stored in the energy store and/or in the heat transfer fluid exceeds an excess threshold.

The reactor may further comprise a regenerative ammonia absorber, such as MgCl₂. The regenerative ammonia absorber may be arranged to receive heat from the heat store or from the heat transfer fluid to regenerate the ammonia absorber. The heat from the heat store or from the heat transfer fluid may alternatively be used to drive other chemical reactions.

The synthesis gas may comprise hydrogen and nitrogen.

The present invention further provides an energy storage system comprising: one or more intermittent sources of renewable energy; an electrolysis unit for producing hydrogen using the renewable energy; and a reactor as set out in the preceding paragraphs which is arranged to generate ammonia from the produced hydrogen.

The one or more intermittent sources of renewable energy may comprise one or more wind turbines, and/or one or more solar panels.

The present invention further provides a method of generating ammonia from a synthesis gas by an exothermic reaction, the method comprising: flowing the synthesis gas through, or into, a reaction volume of one or more reactor modules, the reaction volume containing a catalyst for the exothermic reaction; flowing a heat transfer fluid through a heat transfer volume of the one or more reactor modules and through a heat store; and selectively transferring heat, by controlled flow of the heat transfer fluid, from one or more of the reactor modules which are in a production state in which ammonia is being generated, to the heat store, and selectively transferring heat, by controlled flow of the heat transfer fluid, from the heat store, to one or more of the reactor modules which are in an idle state in which ammonia is not being produced.

The method may further comprise selectively transferring heat, by controlled flow of the heat transfer fluid, from one or more of the reactor modules which are in the production state, directly to one or more of the reactor modules which are in the idle state. That is, the heat may be transferred from one or more production reactor modules to one or more idle reactor modules without first passing through the heat store.

The method may further comprise maintaining one or more, or all, of the reactor modules which are in the idle state at or above a minimum production temperature by transfer of heat using the heat transfer fluid, from the heat store and/or from one or more of the reaction modules which are in the production state. The minimum production temperature may be the temperature for a reactor module to be in the production state, that is, the minimum production temperature may be the temperature at which the reaction is sustained and not quenched.

The method may further comprise raising the temperature of at least a portion of said reaction volume to at least the minimum production temperature using the heat transfer fluid to transfer heat from the heat store or from one or more other ones of the reaction modules which are in the production state.

The method may further comprise transitioning any of the reactor modules from the idle state to the production state. The transitioning may include introducing a production flow of the synthesis gas through, or into, the reaction volume of the reactor module in the idle state.

The method may further comprise controlling the flow of heat transfer fluid such that if one or more of the reactor modules are in the production state, the heat transfer fluid from the one or more reactor modules is directed to supply heat to the heat store.

The method may further comprise separating, in a separator arranged to receive the synthesis gas following flow through at least the reactor modules currently in the production state, ammonia from the received synthesis gas, and returning the synthesis gas to at least the reactor modules currently in the production state.

The method may further comprise transferring heat from the synthesis gas flowing from the reactor modules to the separator to the synthesis gas flowing from the separator to the reactor modules by a recuperative heat exchanger.

Flowing the synthesis gas through, or into, the reaction volume of one or more reactor modules may comprise flowing synthesis gas through a plurality of reaction tubes in parallel, each containing said catalyst.

The method may comprise directing the heat transfer fluid through each reactor module only in the same direction as the flow of synthesis gas through the reactor module.

The present invention may further comprise a controller configured to control the reactor as set out herein. The present invention may further comprise a computer readable medium having stored thereon instructions to cause a processor to control a reactor as set out herein.

The present invention further provides a method of generating ammonia using one or more intermittent and/or variable output renewable energy sources comprising: using a reactor to convert hydrogen generated using the renewable energy to ammonia, wherein the overall turndown ratio of the reactor is higher than the turndown ratio of each of a plurality of reactor modules comprised in the reactor; and reducing a progression time to transfer any of the reactor modules from an idle state to a production state by recycling heat obtained from one or more of the reactor modules in the production state to one or more of the reactor modules in the idle state.

The method may comprise using a stratified heat store to store heat generated by one or more of the reaction modules when in the production state, and subsequently delivering the stored heat to one or more of the reaction modules when in the idle state.

The intermittency and/or variability of the output of the one or more renewal energy sources may be accommodated by the reduced progression time to transfer any of the reactor modules from an idle state to a production state. This may avoid the need to accommodate the variability early in the process by use of hydrogen storage tanks, which are difficult and costly, or battery energy storage, which may be inflexible.

The method may comprise reducing curtailment of the output or usage of the one or more intermittent and/or variable output renewable energy sources.

In an embodiment the reactor may not include a heat store and in that case the present invention provides a reactor for generating a product such as ammonia from a synthesis gas by an exothermic reaction, comprising: a plurality of reactor modules each comprising a reaction volume which contains a catalyst for the exothermic reaction and which is arranged to a receive the synthesis gas, and a heat transfer volume arranged to receive heat transfer fluid for delivering heat to or receiving heat from the reaction volume, each reactor module arranged to be in a production state in which the product is being generated or an idle state in which it is not being generated; and a control system arranged to selectively transfer heat, by controlled flow of the heat transfer fluid, from one or more of the reactor modules which are in the production state to one or more of the reactor modules which are in the idle state.

In embodiments in which the reaction is not ammonia generation but generation of another product, the present invention provides a reactor for generating the product from a synthesis gas by an exothermic reaction, comprising: a plurality of reactor modules each comprising a reaction volume which contains a catalyst for the exothermic reaction and which is arranged to a receive the synthesis gas, and a heat transfer volume arranged to receive heat transfer fluid for delivering heat to or receiving heat from the reaction volume, each reactor module arranged to be in a production state in which the product is being generated or an idle state in which it is not being generated; a heat store coupled to each of the reactor modules so as to controllably receive the heat transfer fluid from, or deliver the heat transfer fluid to, any of the reactor modules; and a control system arranged to selectively transfer heat, by controlled flow of the heat transfer fluid, from one or more of the reactor modules which are in the production state, to the heat store, and to selectively transfer heat, by controlled flow of the heat transfer fluid, from the heat store, to one or more of the reactor modules which are in the idle state.

In embodiments in which the reactor operates as a flow through process rather than a batch process, the present invention provides a reactor for generating a product such as ammonia from a synthesis gas by an exothermic reaction, comprising: a plurality of reactor modules each comprising a reaction volume which contains a catalyst for the exothermic reaction and which is arranged to a receive a through flow of the synthesis gas, and a heat transfer volume arranged to receive a through flow of a heat transfer fluid for delivering heat to or receiving heat from the reaction volume, each reactor module arranged to be in a production state in which the product is being generated or an idle state in which it is not being generated; a heat store coupled to each of the reactor modules so as to controllably receive the heat transfer fluid from, or deliver the heat transfer fluid to, any of the reactor modules; and a control system arranged to selectively transfer heat, by controlled flow of the heat transfer fluid, from one or more of the reactor modules which are in the production state, to the heat store, and to selectively transfer heat, by controlled flow of the heat transfer fluid, from the heat store, to one or more of the reactor modules which are in the idle state.

### BRIEF SUMMARY OF THE DRAWINGS

Embodiments of the invention and aspects of the prior art will now be described, by way of example only, with reference to the accompanying drawings of which:

FIG. 1 is a schematic diagram showing renewable energy sources connected to a national power grid;

FIG. 2 is a process flow diagram of an ammonia production process;

FIG. 3a is a detailed schematic diagram of a reactor according to the present disclosure;

FIG. 3b is a detailed schematic process flow diagram of apparatus for producing hydrogen and nitrogen such as for use in the reactor of FIG. 3a;

FIG. 4 is a perspective diagram of a full plant design for the reactor of FIG. 3a;

FIG. 5 is a perspective diagram of two reactor modules and piping of the reactor of FIG. 4;

FIGS. 6a-6d are respectively a perspective view of a reactor module of FIG. 3a when oriented horizontally, a perspective view of the reactor module of FIG. 6a with insulation removed, a cross-sectional view of the reactor module of FIG. 6a taken in the lengthwise direction, and a cross-sectional view of the reactor module of FIG. 6a taken as a slice through the reactor module in a direction orthogonal to the longitudinal direction;

FIG. 7 is a schematic cross-sectional view comparing the number of reactor tubes in first and second reactor modules;

FIGS. 8a and 8b are diagrams of two alternative flow paths for the heat transfer fluid circuits of the present disclosure, in which the first reactor is in production mode and is providing heat to maintain the temperature of the second reactor ready for start-up;

FIG. 9 is a flow path diagram similar to that of FIG. 8b but for which the second reactor is in production mode and is providing heat to maintain the temperature of the first reactor ready for start-up;

FIG. 10 is a flow path diagram similar to that of FIG. 8b but for which the first and second reactors are in production mode and are providing heat to the heat store;

FIG. 11 is a flow path diagram similar to that of FIG. 8b but for which the heat store is providing heat to the first and second reactors;

FIG. 12 is a flow path diagram similar to that of FIG. 8b but for which the first reactor is in production mode and the first reactor and heat store are providing heat to the second reactor ready for start-up;

FIG. 13 is a flow path diagram similar to that of FIG. 8b but for which the second reactor is in production mode and the second reactor and heat store are providing heat to the first reactor ready for start-up;

FIG. 14 is a schematic diagram of a reactor vessel of the reactor according to a second embodiment, with surrounding insulation;

FIG. 15 is a piping and instrumentation diagram of a reactor according to the second embodiment;

FIGS. 16A, 16B and 16C are detailed drawings of the reactor vessel and aspects thereof, including a flow tube passing internally through the vessel;

FIG. 17 is diagram from a 3D CAD model of a reactor according to the second embodiment;

FIG. 18 are four plots showing the temperature and mass fraction ammonia (FIGS. 18A and 18B) through the reactor vessel at 10% generation rate and full generation rate (FIGS. 18C and 18D);

FIG. 19 is a schematic diagram showing the narrowed width of the reactor vessel and a quench inlet at a mixing zone of the reactor vessel;

FIG. 20 is a schematic piping diagram showing the control strategy of the heat exchangers and bypasses;

FIG. 21 is a table of example flow rates of synthesis gas through the main inlet, first quench inlet and second quench inlet, along with reaction rates and temperatures;

FIG. 22 is a flow chart showing how the various generation rates are linked to the flow rates and other aspects; and

FIG. 23 is a flow chart showing the overall control strategy for the reactor and energy storage system according to the present invention.

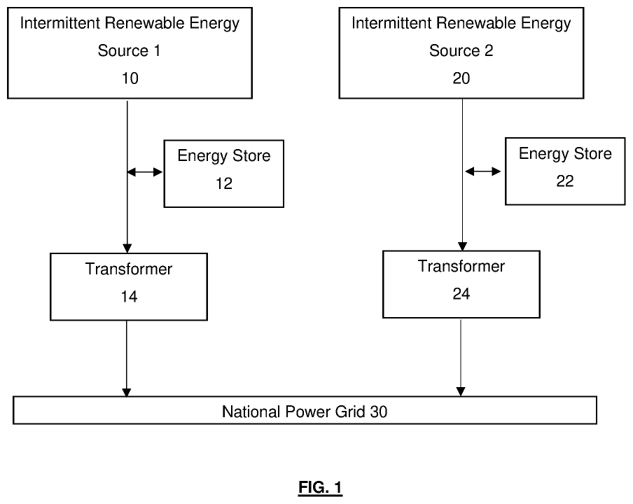

### DETAILED DESCRIPTION OF EMBODIMENTS

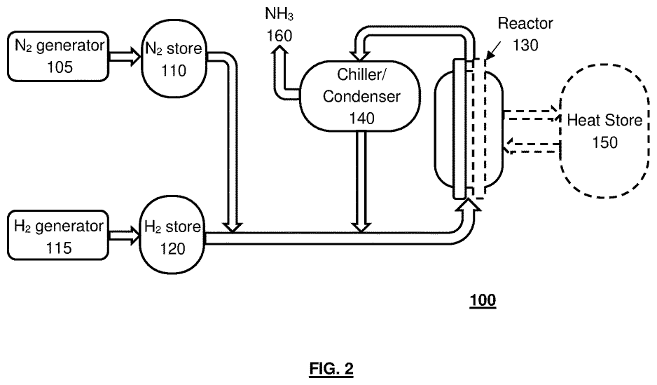

FIG. 2 is a schematic process flow diagram for an ammonia production scheme 100. There is shown schematically a nitrogen generator 105 and a hydrogen generator 115. Further details of example nitrogen and hydrogen generators are provided later in this document. The generated nitrogen and hydrogen are stored in stores 110 and 120. The nitrogen and hydrogen are combined before reaching the reactor module 130 to produce a gas mixture known as synthesis gas. The synthesis gas is directed to reactor module 130. The reaction of nitrogen and hydrogen is by the Haber-Bosch process involving high temperature and pressure. A catalyst may also be used to lower the temperature and/or pressure required for the reaction. A catalyst that maybe used is Katalco by Johnson Matthey. Suitable catalysts may be considered to have an activation temperature of around 300-400° C., such as around 350° C. The catalyst may actually operate below the activation temperature but below this temperature its efficiency tapers off. For example, the rate of production of product on the catalyst changes with temperature, at a rate of about around a 10× increase in rate for a 20° C. increase in temperature. The change in rate will depend on the catalyst, reaction and conditions. Below the activation temperature the activity of the catalyst becomes too low to be reasonably useable. A minimum production temperature may be defined at which the reaction is sustained in the reactor module without quenching. The minimum production temperature may vary dependent on reactor conditions but will be equal to or greater than a catalyst activation temperature, and may be less than a normal production reaction temperature. Typical normal production reaction temperatures may be between 40° and 500° C. or higher, or between 35° and 450° C. Once the reaction is proceeding the reactor module will heat up, by the heat of the exothermic reaction, from the minimum production temperature to a normal production temperature. The reaction pressure may be at least 20 bar or at least 50 bar or may be higher such as around 100 bar.

The Haber-Bosch process is not 100% efficient. Hence, after passing through reactor module 130 the ammonia product is mixed with unreacted synthesis gas. This gas mixture is passed to chiller/condenser 140 which condenses out the ammonia 160. Ammonia condenses at a higher temperature than the hydrogen and nitrogen which remain as gases. The ammonia 160 may be stored or used for processes such as energy production through burning, fertilizer production or other processes. The remaining synthesis gas is returned to the input synthesis gas to be fed back to the reactor 130.

The reaction is an exothermic process and so generates heat. Excess heat may be removed from the process and sent to heat store 150. The heat in the heat store may be stored and used to reheat the reactor module 130 to a minimum production temperature if the reaction stops. Alternatively, the reactor may comprise two or more reactor modules and heat from the heat store may be used to heat up a second or other reactor modules to a minimum production temperature. In a further alternative, a heat store may not be provided and heat from the first reactor module may be used to heat up a second reactor module. Heat may be passed from one reactor module to another or to/from reactor module by use of a heat transfer fluid. In this way various numbers of reactor modules may be provided and heat may be exchanged between them, with or without a heat store. However, if the plant is small and the renewable energy source is intermittent or drops to low levels and restarts are more likely, then a heat store is preferably provided.

Reactor modules may have some ability to run at reduced production rates. This is known as the turn-down ratio and is defined by the ratio of minimum production rate: maximum production rate, while maintaining the reactor module running. A conventional reactor module may have a turn-down ratio of 2:1. We describe in detail in the following embodiments reactor modules that are capable of achieving higher turn-down ratios such that they are better able to accommodate variability in output from renewable energy sources. In a later embodiment we describe a high-turn down ratio reactor in which multiple segments are included in a single vessel.

Although we describe the reaction process as that of ammonia production, the apparatus and methods described herein may be used for other reaction processes, especially those that are exothermic.

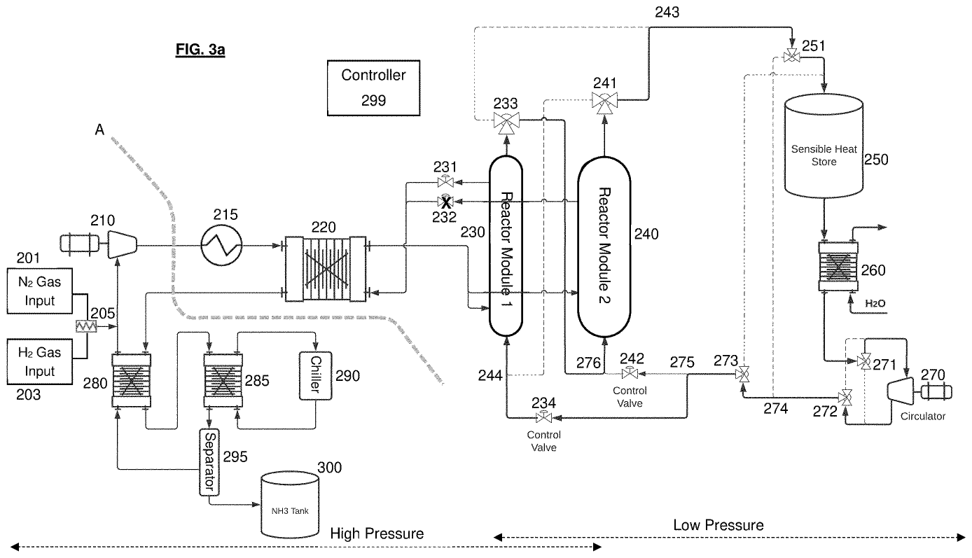

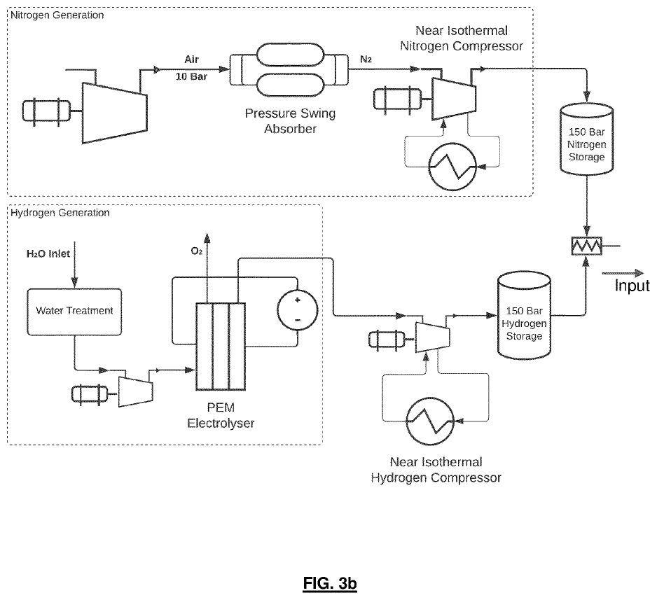

FIG. 3a is a plant diagram showing the components in a reactor 300 according to the present disclosure. The plant diagram relates to the Haber-Bosch process as for FIG. 2. The reactor of FIG. 3a includes two reactor modules and includes thermal management for partial load operating over a wide turn-down ratio. A controller is also provided for controlling the flow of heat transfer fluid and synthesis gas.

At the base of FIG. 3a are arrows relating to high pressure and low pressure. The high pressure arrow indicates that the left side of the figure shows process flow components running at high pressure, that is, the high pressure such as 20, 50 or 100 bar required for the Haber-Bosch process. The process components on the left side relate to the synthesis gas and the production of ammonia. The low pressure arrow is found on the right side of the figures. Accordingly, the process components to the right side relate to control and flow of heat transfer fluid, which operates at a lower pressure than the synthesis gas system. For example, the heat transfer fluid may operate at no more than 10 bar or no more than 2 bar.

In more detail, the reactor system plant diagram of FIG. 3a is shown as receiving nitrogen gas at 201 and receiving hydrogen gas at 203. As discussed these may be received from stores of gases produced by surplus renewable energy. Example processes for producing these gases is shown in FIG. 3b. Returning to FIG. 3a, the nitrogen and hydrogen are combined at mixer 205 to produce synthesis gas. As for FIG. 2, synthesis gas is a mixture of nitrogen gas and hydrogen gas. An input flow path is provided to direct the synthesis gas to the reactor modules via various temperature conditioning components. The input gas flow path comprises a recycle compressor 210 and heater 215. The heater may be a cold-start or black-start heater for heating the synthesis gas to reaction temperatures when the reactor system is initiated. Other heating mechanisms may be provided in the reactor system such that heater 215 may be considered to be an auxiliary heater. The gas flow path next comprises a heat exchanger 220. This heat exchanger 220 is a recuperative heat exchanger for extracting heat from gases that have flowed through the reactors. Other recuperative heat exchangers may be provided in the reactor system but heat exchanger 220 is considered to be the main or hot recuperative heat exchanger because it performs more heat exchange than other heat exchangers in the system.

FIG. 3a shows two reactor modules 230, 240. The first reactor module is smaller than the second reactor module. We will describe later more details of the two reactor modules and their relative sizes. FIG. 3a shows a flow path from the recuperative heat exchanger 220 which splits to direct synthesis gas to the two reactor modules 230, 240. When the reactor system is operating either one, or both, of the reactor modules may be running. The synthesis gas is introduced to the reactor modules 230, 240 at inlets towards the bottom of the modules. Towards the top of the modules is provided an outlet through which gas flows out of the reactor. This gas will comprises synthesis gas as well as ammonia gas product. Valves 231 and 232 at the outlet of the two reactor modules control whether gas flows through one or both of the reactor modules 230, 240. For example, valve 231 controls whether there is gas flow through the first reactor module 230 and valve 232 controls whether there is gas flow through the second reactor module 240. In an alternative arrangement, the valves may be provided in the flow path just prior to the inlet to the reactor modules. The gas output from the reactor modules is directed back to the main recuperative heat exchanger 220. Here heat from the outlet gas is extracted and used to heat the incoming synthesis gas. Two further heat exchangers 280 and 285 are provided in the gas flow path. Of these, secondary recuperative heat exchanger 280 is next in the flow path. This is considered to be the cold recuperative heat exchanger because it does not operate at as high temperatures as the main recuperative heat exchanger 220. The secondary recuperative heat exchanger extracts more heat from the gas that has passed through the reactor module. The other heat exchanger 285 is a condenser. In the condenser the gas from the reactor modules is cooled further. The condenser is cooled by coolant or refrigerant that is cycled through chiller 290. The condenser cools the gas passing through it such that the ammonia product condenses to liquid. The temperature of the condenser is set equal to, or below, the temperature at which the ammonia condenses at the relevant gas pressure or partial pressure. For example, if the ammonia partial pressure in the condenser is 10 bar, ammonia will condense at around 25° C. and the condenser is set to cool to around −20° C. The hydrogen and nitrogen will not condense because the condenser temperature will be much higher than the temperatures at which they condense. At the output of condenser 285 is a separator 295. This may be a gas/liquid separator to separate the liquid ammonia from the gaseous hydrogen and nitrogen. A tank 300 may be provided to store the liquid ammonia. A return flow path is provided to return the nitrogen and hydrogen to combine with the input synthesis gas. The return flow path takes the nitrogen and hydrogen gases from the separator 295 back to the secondary heat exchanger 280 which reheats the gases using heat exchanged from the gases arriving at the secondary heat exchanger 280 from the main recuperative heat exchanger 220. The reheated gases are mixed with incoming synthesis gas and continue on the input flow path to the reactor modules as previously described.

As mentioned, FIG. 3a also shows a low pressure heat store loop for storing and using excess heat generated in the reaction modules 230, 240, and also for supplying heat from a heat store 250 to heat up the reaction modules. The heat store loop cycles heat transfer fluid. Reactor modules 230, 240, include a heat transfer volume. The direction of flow of the heat transfer fluid through the reactor modules is from bottom to top whether heat is being extracted or supplied. The heat transfer fluid flows into the reactor module at, or near, the bottom of the reactor module and flows out of the reactor module at, or towards, the top of the reactor module. Valves 233 and 241 are three-way valves provided on the heat store loop for directing heat transfer fluid that has passed through the reactor modules. For example, valves 233 and 242 may be located close to the top of the reactor modules 230 and 240. The valves control whether the heat transfer fluid is supplied directly to the heat store or whether the heat transfer fluid is supplied to the other of the two reactor modules. In FIG. 3a the heat transfer fluid flow paths are shown with some solid lines and some dashed lanes. The solid lines indicate flow paths that are in use, whereas the dashed lines show flow paths that are not in use for the particular configuration. The configuration of FIG. 3a shows flow paths configured for the first reactor 230 heating the second reactor 240 and returning any excess heat to the heat store. Heat store 250 may be a stratified heat store comprising basalt pieces for storing heat. The low pressure heat loop further comprises a heat exchanger 260 for using excess heat. The excess-heat heat exchanger 260 may be used, for example, to heat water into steam to generate power. Low pressure heat loop further comprises a circulator 270 for pumping the heat transfer fluid round the heat transfer loop, a number of other valves for selecting the direction of heat transfer fluid flow, and piping connecting the various components. Depending on whether heat is being supplied to, or from, the heat store, the heat transfer fluid will flow up through the heat store (for heating one or more of the reactors) or down through the heat store (for heat being received to heat the heat store).

In FIG. 3a three-way valve 233 is connected to the top of the first reactor module 230. The other two ports of the three-way 233 valve are connected to piping which respectively provide flow paths towards valve 251 and heat store 250, and towards the bottom of the second reactor 240. In the configuration shown the three-way valve 233 directs heat transfer fluid to piping to the bottom of the second reactor 240. A three-way valve 241 is similarly provided connected to the top of the second reactor 240. The other two ports of the three-way valve 241 are connected to piping which respectively provide flow paths towards valve 251 and on to heat store 250, and towards the bottom of the first reactor 230. In the configuration shown the three-way valve 241 directs heat transfer fluid to piping to the valve 251 and on to heat store 250. The flows paths from three-way valves 233 and 241 towards the three way valve 251 and heat store 251 combine or join together at junction 243.

Three way valve 251 which is connected to piping coming from valves 233 and 241 at the tops of the reactor modules 230 and 240 has two further ports. One of these ports is connected to piping to connect to the top of heat store 250, as mentioned. The other port is connected to junction 274 between three-way valve 273 and three-way valve 272. In the configuration shown three-way valve 251 directs heat transfer fluid to the top of heat store 250. Piping from the bottom of the heat store connects to heat exchanger 260. Further piping connects heat exchanger 260 to three-way valve 271 and towards circulator such that a flow path for the heat transfer fluid is provided from valve 251 through heat store 250 and heat exchanger 260 to a port of valve 271. Valve 271 has two further ports which are respectively connected to opposing sides of the circulator 270. A further three-way valve 272 is connected in parallel to three-way valve 271 with two ports connected to opposing sides of the circulator 270. The third port of three-way valve 272 is connected to piping which connects to three way valve 273. In the arrangement shown in FIG. 3a the valves 271 and 272 are set such the heat transfer fluid is directed through the circulator in a direction such that the heat transfer fluid is pumped from heat exchanger 260 to three-way valve 273.

We referred to three-way valve 251 as having a port connected to piping to heat store 251. The third port of three-way valve 251 is connected to junction 274 for directing heat transfer fluid towards circulator 270. This allows the direction of flow of heat transfer fluid through the heat store to be reversed. This is achieved by passing to the circulator before passing to the bottom of the heat store. We have also mentioned three-way valve 273 which is connected via piping to junction 274 and three-way valve 272. The other two ports of three-way valve 273 connect to piping for directing heat transfer fluid to the reactors 230, 240 and to piping connected to the top of heat store 250. This path provides the continuation of the reverse flow through the heat store.

Control valves 234 and 242 respectively connect piping to the bottom of the first and second reactors 230, 240. By adjusting each of these control valves the flow of heat transfer fluid into each of the reactors 230, 240 can be turned off, turned on or the flow rate adjusted. Junction 275 is provided in piping between three-way valve 273 and the control valves 234 and 242. Junction 275 splits the flow path in the piping coming from the valve 273 to supply to both control valves 234 and 242 (although actual flow through these valves depends on whether they are open or not, as previously described). In the arrangement shown control valve 242 is turned off such that the path of the heat transfer fluid is from three-way valve 273 through control valve 234 only. Accordingly, in the arrangement of FIG. 3a the heat transfer fluid is shown flowing to the first reactor module 230.

The flow path or piping from control valve 242 to the second reactor module 240 joins the flow path or piping from three-way valve 233 and first reactor module 230 at junction 276 connected to the bottom of the second reactor 240.

The flow paths in use in FIG. 3a provide the following functionality. The first reactor module 230 is running and ammonia generated from it is stored at tank 300. Valve 232 is turned off such that second reactor module is not running. Any unused hydrogen and nitrogen gas from the first reactor 230 is combined with the synthesis gas input flow for further reaction. The heat transfer flow path takes excess heat from first reactor module 230 and uses it to heat up the second reactor module 240. Any excess heat from the second reactor module 240 is stored in the heat store or used to heat water to generate power.

The heat transfer system is separate to the reaction piping. The heat transfer system operates at lower pressure than the reaction piping. The reduced pressure requirements in comparison to the reaction piping makes it easier to manufacture, build and maintain, thereby saving costs in comparison to a heat transfer system operating at the same pressure as the reaction.

As shown in FIG. 3a, the direction of flow of the heat transfer fluid through the reactor modules 230, 240, is the same as the direction of flow of the synthesis gas, namely upwards. By having both flow directions upwards the hottest parts of the heat transfer fluid and reaction are both found at the top of the reactor modules. This maximises thermal efficiency when the heat transfer fluid is heating the reactor module(s). This co-current flow also provides optimal direction of flow when the heat transfer fluid is cooling the reactor module(s) for the exothermic synthesis reaction. Reaction rate is dependent on temperature, absolute pressure and partial pressure of gasses. At the inlet to the reactor module the concentration of reaction product is low and as a result the reaction rate and concentration of exothermic energy release will be highest there. Co-current flow heat exchangers have a maximum temperature difference on the inlet side, resulting in the highest heat flux or heat transfer occurring at the inlet side. This means that the co-current flow results in a more stable synthesis gas/product temperature. Furthermore, the temperature of the reactants increase over the length of the reactor module from the inlet to the outlet due to the release of heat from the exothermic reaction. By having the heat transfer fluid follow the same thermal gradient maintains the maximum difference in temperatures between synthesis gas and heat transfer fluid thereby maximising heat removal.

A controller 299 is provided to control whether one or both reactor modules operate by controlling the various valves on the reaction piping. The controller 299 also controls the flow of heat transfer fluid such that heat is supplied from or to the reactor modules and heat store as required. The controller has a processor and memory which store various instructions and algorithms for the said control. The reactor apparatus may comprises various temperature and pressure sensor throughout the reaction piping and heat transfer fluid cycle.

FIG. 3b is a schematic plant diagram showing apparatus for extracting nitrogen from air and electrolysing hydrogen from water as may be used as starting gases for the production of ammonia. These gases may be stored and/or mixed together and used as the synthesis gas at the input to the apparatus of FIG. 3a. The nitrogen generator may be based on a pressure swing absorber (PSA). Firstly, air is taken from the atmosphere and compressed to a pressure of around 10 bar. The compressed air is then passed through the pressure swing absorber. A pressure swing absorber works by trapping oxygen molecules from the compressed air stream by a process of adsorption. The oxygen molecules bind to a material such as a carbon molecular sieve (CMS). As shown in the figures there are generally provided two pressure vessels that work by alternately trapping the oxygen molecules in the CMS and then swapping the flow of compressed air between the two vessels to flush out the oxygen. The process then repeats. The PSA nitrogen generator requires compressed air in the separation of nitrogen and the air compressor may be powered by the surplus electricity from an intermittent or variable output renewable energy source such as wind turbines and solar panels. Once the nitrogen has been generated it is compressed further for storage, for example, in a 150 bar storage vessel. Again surplus electricity may be used to power the compressor, which may be a near isothermal nitrogen compressor.

The hydrogen generator may be based on a proton exchange molecule or polymer electrolyte membrane (PEM) electrolyser that generates hydrogen from water. Firstly, water is treated such as by filtering and deionization. The water is then pumped at the required pressure to the PEM electrolyser. The required pressure may be an intermediate pressure below the synthesis reactor pressure such as up to around 60 bar. The PEM electrolyser may also utilise surplus electricity from intermittent or variable supply renewable energy sources. Once the hydrogen has been generated it is stored in a similar manner to the nitrogen, such as by compressing and storing in a 150 bar storage vessel.

After generating and storing the nitrogen and hydrogen, the nitrogen and hydrogen are delivered to the mixer and input to the reactor system described in FIG. 3a.

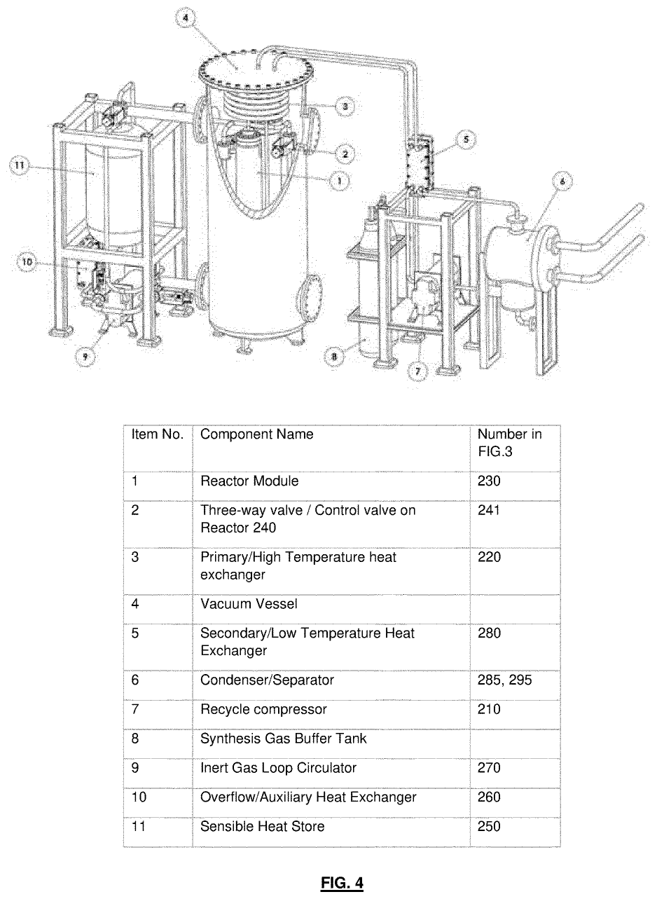

FIG. 4 is perspective view of a practical design of the reactor system of FIG. 3a. An equivalence table is also provided in FIG. 4 identifying the location of components in the practical design. We now explain the design of FIG. 4 in more detail. In the centre of the figure is a large cylinder 4. This is a high temperature vacuum vessel (not shown in FIG. 3a) in which the reactor modules 230, 240 and main recuperative heat exchanger 220 are provided. The reactor modules 230, 240, and main recuperative heat exchanger are surrounded by 50 mm thick insulation such as microporous insulation. The vacuum vessel also helps to reduce heat loss to the surroundings by eliminating conduction and convection. External heat transfer fluid feed pipes are preferably also vacuum insulated.

Provided in vacuum vessel are three-way valves 233, 241, with the three-way valve 241 for the second reactor module listed as item 2. To one side of the vacuum vessel are provided components performing heat transfer operations and on the other side are reaction cycle components. In the example arrangement of FIG. 4, the heat transfer fluid circulator 270 is shown on the left side at the bottom and a pipe connection to the vacuum vessel can be seen. Excess or overflow heat exchanger 260 can also be seen. Above these components is heat store 250. On the right side of the figure secondary heat exchanger 280 can be seen connected to the vacuum vessel by piping. Condenser 285 and separator 295 are identified as being provided in vessel having item number 6. Recycle compressor 210 is identified at item 7 in FIG. 4. FIG. 4 also includes a synthesis gas buffer tank. This may be coupled to the compressor 210 to maintain and buffer the flow and pressure of synthesis gas in the reactor system.

The practical reactor system of FIG. 4 may be sized to fit into a shipping container such as a 20 foot long shipping container. This provides a convenient delivery means for implementing the system at locations of excess renewable energy. The shipping container may also be ATEX rated which is a directive relating to explosive atmospheres. The reactor system is not limited to this size and larger systems of different physical configuration and size may be implemented.

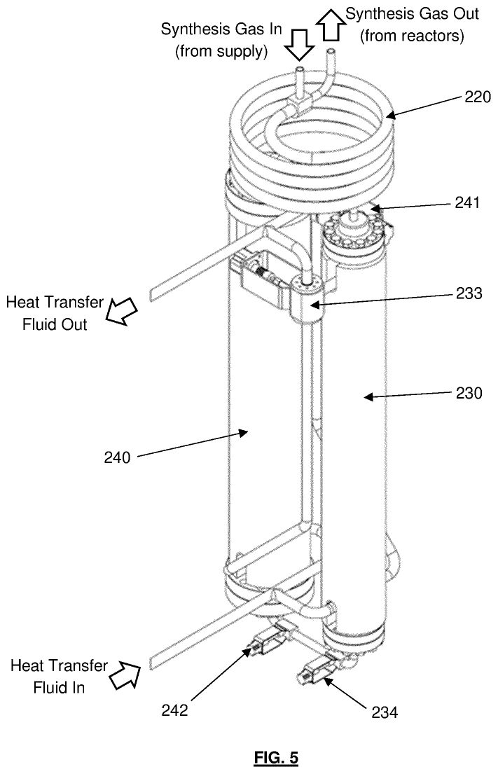

FIG. 5 shows the arrangement of the first and second reactor modules 230, 240, of FIG. 4 in more detail. The larger reactor module on the left is the second reactor module 240 and the smaller reactor module which is the first reactor module 230 is on the right. Again, above the reactor modules can be seen the main recuperative heat exchanger 220. Also shown are valves 233 and 241 which control the flow of heat transfer fluid from the reactor modules out and to the heat store. At the foot of the figure can be seen piping for supplying the heat transfer fluid from the heat store to the reactor modules. Different to the schematic process diagram of FIG. 3a, the heat transfer fluid enters and leaves the reactor modules at the sides of the reactor modules, although as previously described entry is towards the bottom and exit is towards the top of the reactor modules such the flow direction is upwards the same as the synthesis gas. At the bottom of the figure are shown control valves 234 and 242 which control the flow of synthesis gas into the reactor modules, as described previously. Recuperative heat exchanger 220 comprises concentric pipes having a core-shell arrangement. The recuperative heat exchanger is a counter-flow heat exchanger. The synthesis gas input, such as coming from the hydrogen and nitrogen gas stores, flows in an opposite direction to the synthesis gas and any products exiting from the reactors. The synthesis gas and any product coming from the reactors is likely hotter than the gases flowing in from the supply. In the embodiment of FIG. 5 the core pipe is the input line which receives and inputs synthesis gas for the reaction, and the outer shell pipe carries the synthesis gas with (approx. 15%) ammonia product. This arrangement was selected for ease of manufacture. Having the hotter gas in the external shell pipe and the colder gas is in the internal core pipe simplifies the construction of manifolds. In an alternative embodiment, increased heat transfer efficiency may be achieved by having the hot synthesis gas and product from the reactor modules flowing in the core pipe of the concentric pipes and the synthesis gas from the supply for input to the reactor modules flowing in the shell pipe.

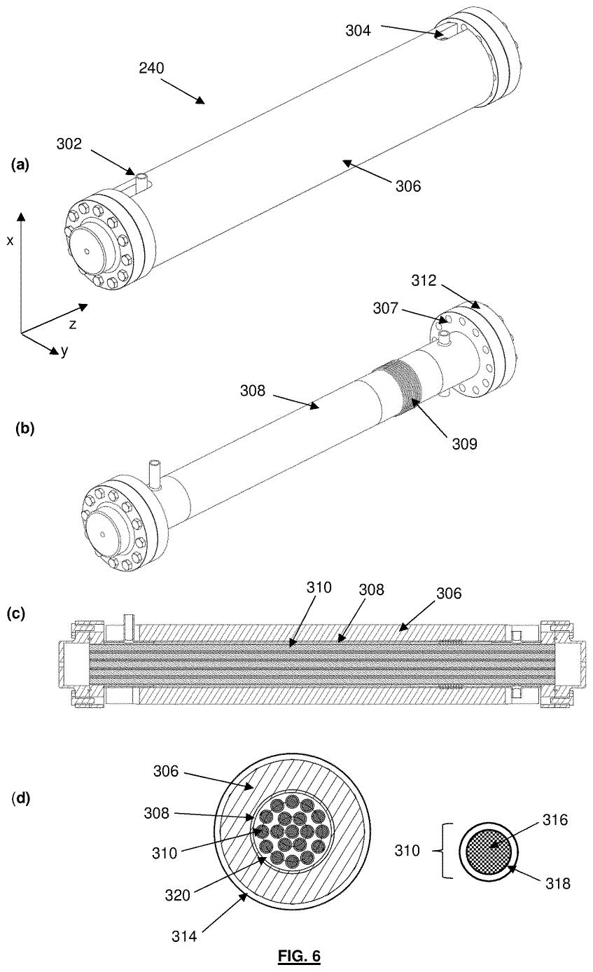

FIGS. 6a-6d show more detail of one of the reactor modules. FIGS. 6a-6d show the larger reactor module which is the second reactor module 240. FIG. 6a is a perspective view of the reactor module 240. For convenience of drawing, the reactor module is shown horizontal but is generally arranged vertically as shown in FIG. 5. FIG. 6a also shows entry and exit ports 302, 304, into and out of which the heat transfer fluid flows. In the figure these are shown towards the ends of the generally cylindrical reactor module 240. FIG. 6b shows the reactor module with thermal insulation removed from around reactor. The thermal insulation is indicated by reference number 306 in FIG. 6a. The thermal insulation may be microporous insulation to a thickness of, for example, 50 mm. Other thicknesses and types of insulation may alternatively be used. With the insulation removed the flange ends of the reactor vessel can be clearly seen in FIG. 6b. The reactor vessel is comprised of a cylindrical tube 308 having flanged ends 307 with plates 312 fixed to the flanged ends to close the vessel. The plates 312 may be fixed to the flanges with bolts. The plates also each include an inlet/outlet port through with synthesis gas may be introduced or may exit from. Also shown in FIG. 6b are bellows 309 which may be provided to allow for increased thermal expansion of the reactor tubes.

FIG. 6c shows the reactor module in cross-section with the cross section taken through the middle of the reactor module in the longitudinal direction, that is along plane x-z in FIG. 6a. FIG. 6d is cross-section through the reactor module taken as a slice orthogonal to the longitudinal direction, that is along a plane parallel to the x-y plane of FIG. 6a but half way along the reactor module. In FIG. 6c the insulation 306 can be seen around the outside of the longitudinal curved surface of the reactor module. Cylindrical tube 308 forming the reactor vessel is shown next as we move towards the centreline of the reactor vessel. Inside reactor vessel are a number of reactor tubes 310. The cross-section shown in FIG. 6d more clearly shows the reactor tubes 310. Also shown in FIG. 6d is an optional casing 314 around the insulation 306 which is not shown in the other figures. In FIG. 6d there are shown nineteen reactor tubes 310. The reactor tubes 310 are clustered together inside the reactor vessel 308. There is space 320 between the reactor tubes within the reactor vessel through which heat transfer fluid flows. One of the reactor tubes 310 is shown in more detail in the inset of FIG. 6d. The reactor tube 310 comprises a cylindrical pipe containing catalyst. Synthesis gas is flowed through the reactor tube. The reaction takes places in the reactor tubes. Hence, the volume inside the reactor tubes may be considered to be the reaction volume. The volume inside the reactor vessel 308 but excluding the reactor tubes is the volume in which the heat transfer fluid may flow. Hence, this volume may be considered to be the heat transfer volume.

FIGS. 6a-d show the second reactor module 240 as having nineteen reactor tubes. The first reactor module 230 is smaller than the second reactor module and may have seven reactor tubes. Other numbers of tubes may be used in the reactor modules. For minimum rate of generation of product, which may be ammonia, only the seven tube reactor module 230 is operated and flow of synthesis gas through the other reactor module 240 is stopped. For intermediate product generation rates only the nineteen reactor module 240 is operated and flow of synthesis gas through the other reactor module 230 is stopped. For maximum generation rates both modules 230, 240, are operated. Further variation in product generation rate may be achieved by reducing the reaction rates, for example, flow of synthesis gas through the reactor tubes. The ratio to which the generation rate may be reduced is known as the turn-down ratio and is defined as:
minimum generation rate:maximum generation rate

We have described how the reactor tubes are clustered together in the reactor vessel. The synthesis gas is flowed through the reactor tubes inside the reactor vessel. The heat transfer fluid is flowed through the reactor vessel in the spaces between the reactor tubes. The heat transfer fluid may be a relatively inert gas such as nitrogen. The heat transfer fluid flow through the reactor vessel can be used to remove heat from the exothermic reaction or to add heat to keep warm or heat up reactor tubes. A thermal management system may be used to keep idle reactor tubes warm by using heat from active or production modules. For example, as shown in FIG. 3a the heat from the active first reactor module 230 may be used to keep warm the reactor tubes in the second reactor module 240. By keeping the idle reactor module warm at near operational temperature the plant can respond near instantly to required increases in generation rate by immediately turning on the idle reactor module.

Although we have discussed an embodiment having two reactor modules 230, 240, more than two reactor modules may be provided to provide an increased range of generation rate. For example, a third reactor module may be provided that has even more reaction tubes than second reactor module 240. Alternatively, multiple reactor modules may be provided some of which may have the same number of reactor tubes.

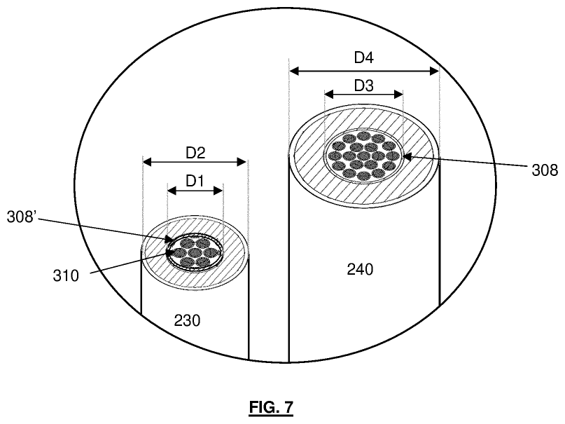

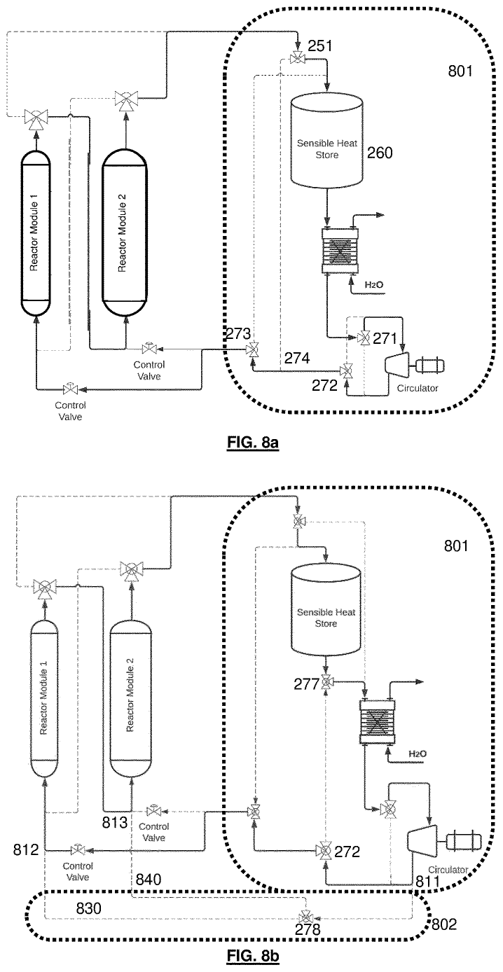

We now provide more detail of the reactor tubes, vessels and reaction rates. FIG. 7 shows a similar cross-section through reaction module as FIG. 6d but cross-sections through both reactor modules 230 and 240 are shown for comparison. The first reactor 230 is shown with the seven reactor tubes 310 therein. In the embodiment shown the reactor tubes 310 have an outer diameter of 22 mm and are stainless steel. The reactor tubes are filled with pellets of catalyst such as Katalco from Johnson Matthey. The reactor tubes are capable of withstanding high pressure. The seven reactor tubes of the first reactor module 230 are surrounded by reactor vessel 308′. Reactor vessel 308′ is a tube having an outer diameter D1 of 90 mm. The reactor vessel is surrounded by insulation which may be microporous mineral insulation capable of withstanding high temperatures. The insulation may be enclosed by a casing. The outer diameter D2 of the insulation and optional casing is 190 mm.

The second reactor module 240 is arranged similarly to the first reactor module 230. The second reactor module has nineteen reactor tubes filled with catalyst, again preferably in pellet form, surrounded by reactor vessel 308. Reactor vessel 308 is a tube having an outer diameter D3 of 140 mm. The reactor vessel is again surrounded by microporous mineral insulation capable of withstanding high temperatures. The insulation may be enclosed by a casing. The outer diameter D4 of the insulation and optional casing is 240 mm. The reactor tubes of both modules may be 1.5 m long. As mentioned previously, the sizes and number of reactor tubes are examples and other numbers of reactor tubes and sizes may be used.

Modelling of ammonia production for a single reactor tube for a range of synthesis gas flow rates shows that the reactor temperature and heat transfer fluid temperature are maintained fairly constant. The modelling was performed for a synthesis gas mass flow rate of between 0.3 g/s and 1.0 g/s. Across this range the reactor exit temperature ranged from 775 to 787 K with a reactor peak temperature of 781 to 790 K. The heat transfer fluid, which was modelled as an ideal gas, had a temperature at the outlet of 773 to 788 K. The heat transfer fluid thermal power increases by 49.8 to 51.5 W. For this range of synthesis gas input rates the ammonia produced ranged from 0.05 g/s to 0.14 g/s with stable operation. This corresponds to stable operation over a ranges of 4.3 to 12.5 kg/day. Based on these flow rates the turn-down ratio of the reactor tubes of 34%.

Taking into account the turn-down ratio, the generation rate for the seven tube reactor module, the nineteen tube reactor module and both reactor modules together the production amounts for ammonia are as set out in the following table.

| | Minimum | Maximum |
|---|---|---|
| | Generation Rate | Generation Rate |
| | kg/day | kg/day |
| Seven Tube Module | 31 | 88 |
| Nineteen Tube Module | 81 | 238 |
| Both Modules Together | 112 | 324 |

Accordingly, by implementing the two different sized reactor modules the turn-down ratio is increased from 34% to around 9.5%, while maintaining stable operation.

In one embodiment intermittent or variable output renewal energy sources, which may include a mix of wind and solar sources, may produce a maximum electrical power output of 137 KW and a minimum electrical power output of 17 KW. This electricity can be used to produce around 300 kg/day at maximum electricity output or around 35 kg/day at minimum electricity output. 300 kg/day of ammonia can provide 1875 kWh of energy when burned or put another way stores 53 kg/day of hydrogen in the ammonia. The minimum value of around 35 kg/day of ammonia can provide 219 kWh of energy when burned or put another way stores 6.2 kg/day of hydrogen in the ammonia.

Returning to FIG. 3a, we described the valve configuration of the heat transfer fluid flow path system. The valve configuration allows instant switching of either reactor module to be configured as either actively producing ammonia or idle with heat transfer fluid heating the reactors. These two states are known as the production state and idle state respectively. A third state of the reactor modules is possible which is the shutdown state in which the reactor modules are not producing ammonia and are not being heated. In such a case the reactors will need to be warmed to reaction temperature before ammonia production can commence. The warm up may use heat from the heat store if sufficient heat remains stored there. Additionally, the cold-start or black-start heater may be needed to warm the synthesis gas further to arrive at reaction temperatures.

As shown in FIG. 3a the heat transfer fluid is provided to both reactors, whether actively producing ammonia or idle with heat transfer fluid maintaining heat in the reactors, the heat transfer fluid is driven around the fluid paths by a single circulator 270. For operating states where reactor modules are both being heated or both are producing ammonia, control valves allow the fraction or percentage of heat transfer fluid flow to each reactor to be controlled dependent on reactor requirements. This may be achieved the amount of opening of valves 234 and 242.

To achieve the full range of turn-down ratios that the reactor tubes can achieve, the circulator 270 must also have a sufficient turn-down ratio or range of flow or pumping rates. Faster reheat times may be achieved using a large or higher capacity circulator. As shown in FIG. 3a, the heat transfer fluid always passes through the excess-heat heat exchanger 260 before returning the heat transfer fluid to the circulator. This is such that the heat transfer fluid, which may be a gas such as nitrogen gas, is at ambient temperature at the circulator to avoid overheating the circulator. If the heat store 250 is saturated, or close to, and cannot take any more heat the heat transfer fluid may exchange heat to heat steam in excess-heat heat exchanger. In this way steam up to 300° C. may be produced, which could be deployed elsewhere such as to drive a small steam turbine or a compressed air driven generator.

Thermal losses in the system are such that at the lowest operating load (i.e. maximum turn-down) the temperature of the second reactor 240 and the heat store 250 may be maintained using the extracted heat from the first reactor module 230. The temperature of the second reactor module is maintained such that the reactor is maintained above a minimum production temperature which is the temperature at which the production of ammonia can be stably maintained. The minimum production temperature may be above the catalyst activation temperature of 350° C. Hence, the second reactor module can start producing ammonia almost immediately from when required. In one embodiment this is achieved by the heat transfer fluid, which is nitrogen gas, arriving at the second reactor module at around 500° C. and leaving the second reactor have lost around 160° C. in temperature to keep the reactor module at least at the minimum production temperature. The reactor module is also preferably insulated such as with 100 mm thickness of microporous mineral insulation.

The heat store 250 is designed to store enough heat energy after 48 hours of no heat being supplied to it so as to reheat both reactor modules to minimum production temperatures. For longer down periods of the reactors electric power heat boosting such as from cold-start or black-start heater 215 may be required. The flow of heat transfer fluid through the reactor modules is in the same direction as the synthesis gas flow. Hence, the heat transfer fluid will first heat the bottom of the reactor module and the reaction can commence at the bottom of the reactor module before the other end is up to minimum production temperature.

In one embodiment the energy required to restart one reactor module is 52 MJ. The heat store has a store volume of 0.2 m³ and is packed with heat store materials such as basalt. The heat storage materials may be arranged in layers to form a stratified heat store. The heat store comprises 0.134 m³ of basalt, which is a packing factor of 0.67. 200 mm thickness of insulation is provided around the heat store. The total basalt weight is 400 kg. This provides capacity for storing 112 MJ of thermal energy. After storing energy for 55 hours the minimum temperature of the store is around 347° C. and the maximum temperature is 355° C. This is sufficient heat to reheat both reactors to the required 350° C. temperature. The heat store can reheat both reactor modules in 50 minutes using a 24 m³/h circulator. The heat store takes greater than one month (31 days) to dissipate heat to ambient through losses to the atmosphere. During this time the heat in the store can be used to reduce the amount of electricity to reheat the reactors.

As previously discussed, FIG. 5 shows the main recuperative heat exchanger 220 for recovering heat from the synthesis gas. This is shown as a core-shell counter-flow heat exchanger formed in a coil. A similar counter flow coiled heat exchanger may be used for the secondary heat exchanger. Heat exchangers should optimise effectiveness across the desired range of operating temperature whilst minimizing pressure drop. The table below provides example dimensions and design details for the main recuperative heat exchanger and secondary heat exchanger.

| | | Outer | Inner | | Max | |
|---|---|---|---|---|---|---|
| | Length | diameter | diameter | Peak | pressure | |
| | (m) | (mm) | (mm) | effectiveness | drop (bar) | Shape |
| Main | 8 | 21.5 | 13.5 | 0.87 | 0.063 | Coiled |
| heat exchanger | | | | | | counter-flow |
| Secondary | 6 | 19.5 | 12 | 0.96 | 0.048 | Coiled |
| heat exchanger | | | | | | counter flow |

The length is the length the inner and outer pipes are in contact to perform heat exchange. The diameters are the diameter of the outer pipe and the inner pipe. Other dimensions of heat exchangers may be used, for example, if different heat exchange capacities are required.

In embodiments heat from the heat store or the heat transfer fluid may be used to regenerate an ammonia absorber, such as MgCl₂. For example, an ammonia absorber may be used to separate ammonia from the synthesis gas instead of using a condenser, as described earlier in this disclosure. An ammonia absorber has the advantage of not requiring the output gases of the process to be cooled down to condense out the ammonia out. A material, such as MgCl₂, is used to absorb the ammonia. Later the absorber is heated causing the ammonia to be released. In this way the ammonia can be extracted more easily at lower pressure and/or without energy use. Furthermore, the heat required to release the ammonia could be derived from the stored thermal energy of the heat store. Alternatively, the heat from the heat store or from the heat transfer fluid may be used to drive other chemical processes such as in other parts of the plant.

We now describe different heat transfer fluid circuit piping configurations and different operating states of the reactor modules and reheat modes.

In FIG. 3a we described the heat transfer fluid flow path along with the synthesis gas flow path. The heat transfer fluid flow path is reproduced as FIG. 8a. FIG. 8b shows an alternative heat transfer fluid flow path piping and valve configuration. The heat transfer paths in both figures are configured with the first reactor module online providing heat to the second reactor module. FIG. 8a has a region of the piping and flow paths marked by reference number 801. A corresponding region 801 is marked in FIG. 8b. These regions show different pipe arrangements between the figures. The heat store 250, excess-heat heat exchanger 260 and circulator 270 are included in region 801 of both figures. Valves 251, 271 and 272 are configured differently in the two figures. In FIG. 8a the valve 251, which is connected to piping to receive heat transfer fluid from the second reactor module, can be switched between two output which respectively connect to piping to the heat store 250 and to piping to connect to junction 274 and on to circulator. With the valve 251 switched to provide flow in the paths shown in FIG. 8a, the heat transfer fluid will flow from valve 251 to heat store 250 and on to heat exchanger 260 and valve 271 where it passes to circulator 270 and past valve 272, junction 274 and valve 273 towards reactor modules again. If the valve 251 is switched to flow heat transfer fluid through its other outlet the heat transfer fluid will flow from valve 251 to junction 274 to valve 272, circulator 270 and valve 271 to excess-heat heat exchanger 260 through heat store and to valve 273. In other words to the two paths may be summarised as:
heat store-heat exchanger-circulator-reactor modules
circulator-heat exchanger-heat store-reactor modules

The valve 272 is FIG. 8b is differently connected such that the two alternative paths are to piping to the heat store 250 and piping to excess-heat heat exchanger 260. In FIG. 8b an additional valve 277 is provided on piping between the heat store 250 and excess-heat heat exchanger 260. Hence, in FIG. 8b the two paths may be summarised as:
heat store-heat exchanger-circulator-reactor modules
heat exchanger-circulator-heat store-reactor modules
   In both figures there is piping that, starting from valve 251, bypasses the heat store 250 but in FIG. 8a the bypass pipe takes fluid towards the circulator 270 whereas in FIG. 8b the bypass pipe takes fluid towards the excess-heat heat exchanger. Both figures also provide piping that returns heat transfer fluid from the heat store to reactor modules for use when the switch 251 is switched such that flow is not to the heat store initially. The advantage of the arrangement of FIG. 8b is in the switched flow path the heat transfer fluid passes through the excess-heat heat exchanger before the circulator which maximises heat transfer and reduces the temperature to which the circulator is exposed increasing its lifetime.

FIG. 8b also includes further pipe connections 830, 840 and valve 278 in comparison to FIG. 8a, as shown in region 802 of FIG. 8b. These extra pipe connections allow an offline reactor be reheated by the heat store as well as the online reactor. Additional valve 278 is connected to flow path piping close to circulator at new junction 811 and receives heat transfer fluid from circulator 270. The valve 278 is a three-way valve with the other two ports respectively connected to piping towards the first reactor 230 and second reactor 240. The pipe flow paths connect to piping at junctions 812 and 813 respectively at the bottom of the first reactor module 230 and second reactor module 240. Hence, valve 278 allows heat transfer fluid to be directed to either of the reactor modules depending on which requires reheating.

In FIGS. 8a and 8b the first reactor module is operating and the second reactor module is offline. The valves in both figures are set such that heat transfer fluid that has been heated by the exothermic reaction in the first reactor module then flows to second reactor module to heat that module. The heat from the first module is sufficient to maintain the second reactor module at a temperature ready for reaction such that reaction could start immediately synthesis gas flow in it starts. After flowing through the second reactor module the heat transfer fluid is directed to the heat store. The heat store, when having capacity to receive more heat, has a high degree of stratification with high temperature media at the top of the vessel and near ambient temperature at the base of the vessel. Between the top and bottom is a sharp thermal gradient. The heat transfer fluid coming from the second reactor module is directed to the top of the heat store vessel to maintain this stratification. The high temperature heat transfer fluid enters from the top of the vessel and deposits heat in the region with the sharp thermal gradient. A high rate of heat transfer in this region, due to the large surface area of heat store storage media, maintains this sharp thermal gradient. Having passed through the heat store the heat transfer fluid passes through the excess-heat heat exchanger and is driven by circulator back towards the first reactor module and the cycle repeats.

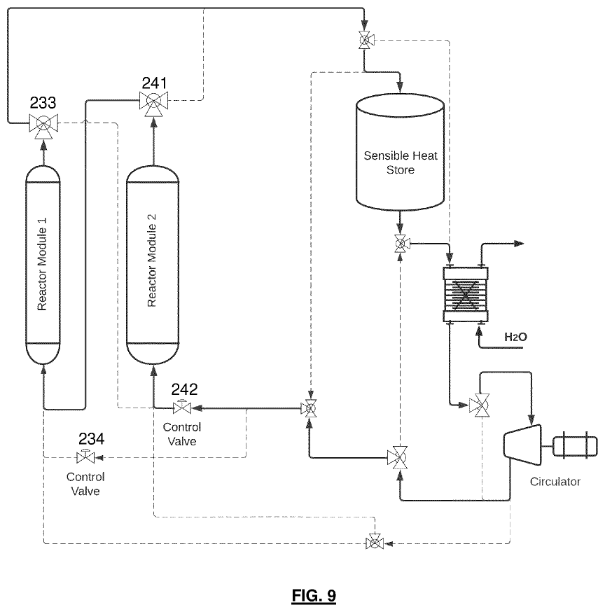

FIG. 9-13 show different operating modes for the heat transfer and thermal management system. The piping connection and valve configuration in FIGS. 9-13 corresponds to that in FIG. 8b except that valve settings are different for the different operating modes.

In FIG. 9 the heat transfer and thermal management system is operating similarly to that in FIGS. 8a and 8b. However, in FIG. 9 the three-way control valve 242 is opened and three-way control valve 234 is closed. This swaps the flow of heat transfer fluid coming from the heat store and circulator to flow through the second reactor module first instead of flowing through the first reactor module first. The route of flow from valves 241 and 233 is also swapped such that after flowing from the second reactor the heat transfer fluid flows to the first reactor module and then back to the heat store. The configuration shown in FIG. 9 has the second reactor active and the first reactor offline. The heat from the exothermic reaction of the second reactor heats the first reactor to maintain it a temperature ready for reaction such that the reaction in the first reactor module can start immediately that flow of synthesis gas is turned on to the first reactor.

In FIG. 10 the heat transfer and thermal management system is operating similarly to in FIGS. 8a/8b and 9. In comparison to these figures both valves 234 and 242 towards the bottoms of both first and second reactor modules respectively are turned on such that heat transfer fluid from the circulator and heat store can flow to both reactor modules. Similarly both valves 233 and 241 connected to the tops of the first and second reactor modules respectively are both set such that the heat transfer fluid flows directly to the heat store instead of flowing to the other of the reactor modules. In FIG. 10 both reactor modules are operating with the reaction running and both are providing heat to the heat store. That is, heat transfer fluid is flowing from both reactors to the top of the heat store to increase the maximum temperature in the heat store.

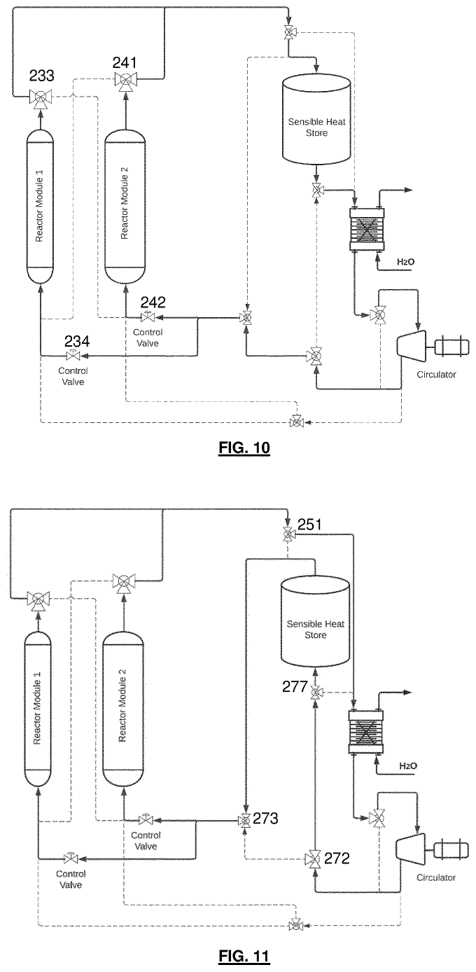

In FIG. 11 the heat transfer fluid flow path is configured such that the heat store is heating up both reactors. In comparison to the arrangement in FIG. 10, the heat transfer fluid path is changed such that the heat transfer fluid, having come from both the reactors is directed to excess-heat exchanger followed by circulator and then to heat store. This change in flow is achieved by switching the three-way valve 251 which in FIG. 9 directs heat transfer fluid to the heat store to instead direct it to the heat exchanger. Valves 272 and 273 are also switched such the fluid is no longer flowing directly from the circulator through the two valves towards the reactors but is instead flowing via the heat store. Valve 277 also requires switching such that the fluid flow from valve 272 is to the heat store. Hence, in FIG. 11 the top of the heat store, which is the hottest part, is connected to the bottoms of the two reactors, such that heat from the heat store is supplied to the two reactor modules to heat them up. This arrangement is used when both reactor modules are transitioning from an off state in which they may both be below reaction temperatures to a state in which both reactor modules are brought as close as possible to reaction temperatures. If the heat store is not able to supply enough heat to the reactor modules, the synthesis gas may also be heated such as with black start heater 215.

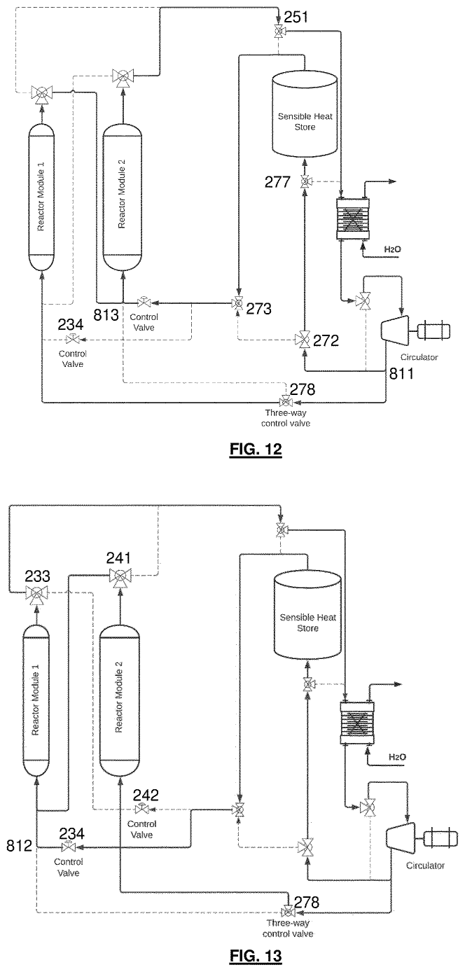

FIG. 12 shows an heat transfer fluid path similar to FIG. 8b in that heat transfer fluid that has passed through the first reactor is directed to flow into the bottom of the second reactor to heat it up. Differently to FIG. 8b, the fluid flow after the reactors is to the excess-heat heat exchanger and circulator first. After the circulator, valve 278 is opened to flow heat exchange fluid to first reactor module. Valve 272 also directs the heat transfer fluid to the heat store. Hence, at junction 811 fluid from the circulator divides with some going directly to the first reactor module and some fluid going to the heat store through valve 277. Valve 273 is set so that heat transfer fluid having passed through heat store is then directed to the second reactor module. Heat transfer fluid from first reactor module joins heat transfer fluid from the heat store at junction 813 such that the first reactor module and heat store are used to heat up the second reactor module. Valve 234 is closed such that heat transfer fluid coming from the heat store does not flow to heat up the first reactor module. By using both the heat store and first reactor module to heat up the second reactor module the second reactor module may be heated more quickly, for example if the first reactor module is running at a relatively low rate such that insufficient heat from the first reactor module is been generated to heat up the second reactor module.

FIG. 13 shows a similar heat transfer fluid flow arrangement to FIG. 12. However, in FIG. 13 heat from the second reactor module and the heat store is used to heat the first reactor module. This is achieved by turning off valve 242 and turning on valve 234 such that heat transfer fluid from the heat store is directed to the first reactor module instead of to the second. Valve 278 is also switched such that heat from the circulator is directed to second reactor module instead of the first. Valves 233 and 241 which control the flow from the top of the reactor modules are also switched such that the heat transfer fluid from the second reactor module flows to the bottom of the first, meeting fluid from the heat store, and fluid from the first reactor module flows back to the excess-heat heat exchanger and circulator.

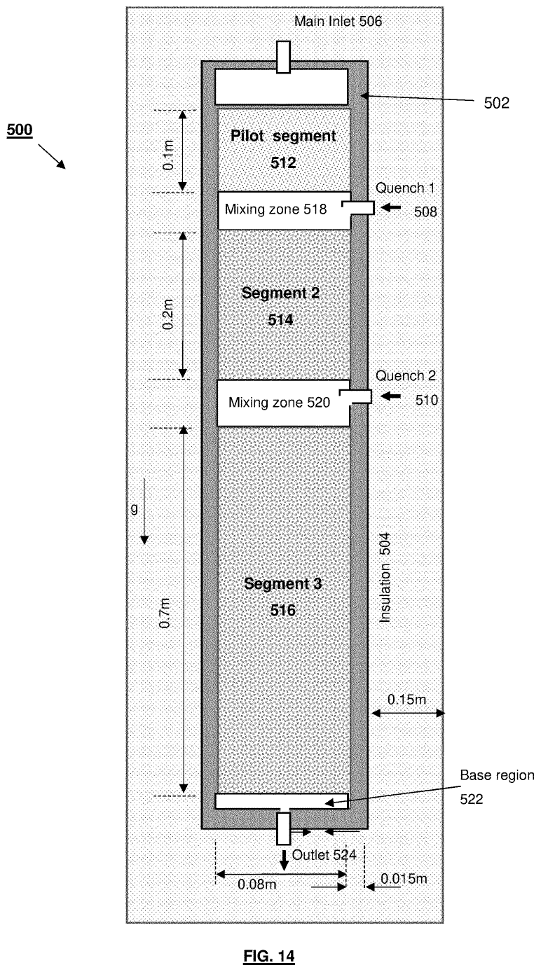

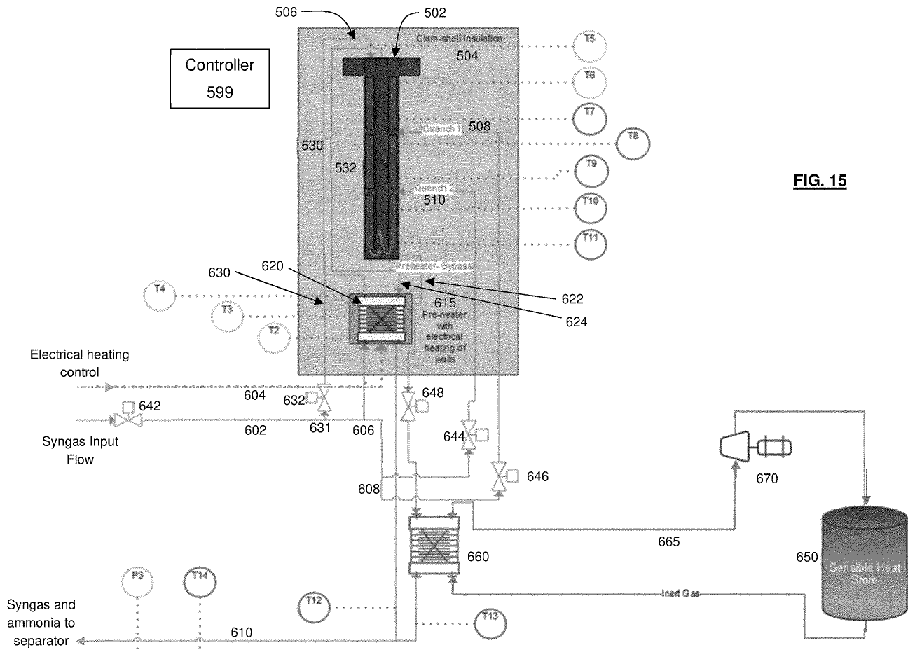

FIGS. 14 and 15 show an alternative embodiment of reactor for generating ammonia from synthesis gas. FIG. 14 is a schematic diagram of a reactor vessel of the reactor, with surrounding insulation. FIG. 15 shows how the reactor vessel fits into the wider reactor in a similar way to the reactor of FIG. 3a. The reactor shown in FIGS. 14 and 15 is different to the reactor of the preceding figures because it does not use multiple reactor modules to achieve a turn-down ratio. The reactor/reactor vessel of FIGS. 14 and 15 may be considered to be an improved design because it has less complexity than of the preceding figures. The reduced complexity also means that there are less transfer lines and flow tubes outside of the reactor modules/vessel that are required to be kept hot by high-levels of insulation to maintain gases close to 500° C. for rapid start-up such as may be needed for the second module. In comparison to FIG. 3a, the reactor 500 instead comprises a reactor vessel 502 with multiple reactor segments 512, 514, 516 in which the ammonia generation may occur. The reactor vessel 502 has multiple inlets. In the arrangement shown the reactor vessel has a first inlet 506 at the top of the reactor which may be a main inlet for synthesis gas. The synthesis gas may be the same as previously described, namely a mixture of nitrogen and hydrogen for generating ammonia as the product. In the embodiment shown, the multiple segments are three segments although other numbers of segments may be used. The segments are arranged vertically one above the other with spaces in between the segments and also at the top and bottom of the vessel. The segments 512, 514, 516 comprise catalyst such as the previously mentioned Katalco by Johnson Matthey, which is a magnetite-based catalyst. The catalyst may be provided as pellets which are held in a basket in the reactor vessel for each of the segments. The first segment, at the top of the reactor vessel, which may be considered to be a pilot segment, may have a lower density or a reduced amount of catalyst compared to the other segments such that the catalyst has a reduced effectiveness to avoid local hot spots in the first segment when the reactor is running at the minimum generation rate. For example, the pilot segment may contain only 25% of active catalyst (per unit volume) compared to the other segments. The second segment 514 and the third segment 516 also include baskets with catalyst in the form of pellets. The second segment and third segment are preferably larger and comprise more catalyst than the first segment, with the third segment also being larger than the second segment. In one embodiment, the size of the segments may be in the ratio 1:2:7 to achieve a turn-down ratio of 10:1 similar to the previously described embodiments. However, other turn-down ratios are possible such as 1:2:>4 where the third reactor segment is at least four times the size of the first reactor segment. Since the reactor segments are all in the same diameter vessel, the increasing size corresponds to an increasing length such as vertical height in the reactor vessel.

Between each of the segments are second inlets which may be called quench inlets. In FIG. 14 second inlets are shown as 508 and 510. Synthesis gas may be selectively input to the second inlets to increase the amount of ammonia generation, as desired. The spaces in between the segments are mixing zones 518, 520, that allow for the synthesis gas that is received from the second or quench inlets to mix with the gases received from the preceding segment. For example, the mixing zone 518 between the first and second segments 512, 514, receives ammonia gas and unreacted synthesis gas from the first segment. Further synthesis gas may be supplied into the mixing zone from the quench inlet 508. The addition of the synthesis gas from the quench inlet 508 reduces the temperature of the gases in the mixing zone and also reduces the proportion of the gas mixture that is ammonia. The catalyst may have a relatively narrow working or optimum temperature range so it is desirable to keep the synthesis gas in this temperature window. The addition of the synthesis gas from quench inlet to cool the gases is used to keep the gas moving into the next segment at the optimum temperature. Furthermore, since the yield from the reaction may be around 20%, the reduction in concentration of ammonia product and increase in the amount of synthesis gas allows more ammonia to be produced by the second reactor segment. Between the second reactor segment and third reactor segment there is further mixing zone 510 which may receive additional synthesis gas from quench inlet 510 before being supplied to the third reactor segment. After the third reactor segment is a space to allow gases to flow to the outlet 524. This is identified in the figure as base region 522. At the top of the reactor there may also be space between the inlet and first reactor segment to allow the synthesis gas to spread across the width of the first reactor segment. In other embodiments the first inlet and the outlet may be arranged such that gas flows are directly to/from the first and third segments without a space at the top and bottom of the reactor vessel. The three segments may be considered to be stacked vertically on one another with mixing zones there between.

As shown in FIG. 14, the reactor vessel is surrounded by insulation 504. This insulation is to maintain the temperature in the reactor vessel at, or as close to as possible, a minimum operating temperature of the reactor while requiring minimal external heating. The reactor configuration is known as an adiabatic quench cooled reactor (AQCR).

FIG. 14 shows various example dimensions for the reactor vessel. These dimensions are for a demonstrator vessel. Other dimensions may be used such as larger sizes for a full scale production reactor. As mentioned, the relative sized of the reactor segments may in the ratio 1:2:7, and the example sizes in FIG. 14 include sizes of 0.1 m, 0.2 m and 0.7 m respectively for the heights of the first, second and third segments. The height of the mixing zones between reactor segments may be 0.05 m. In the example sizes of FIG. 14, the inner diameter of the reactor vessel may be 0.08 m. The walls may be a thickness of 0.15 m. The insulation may be 0.15 m thick around the whole of the vessel.

The first reactor segment may be known as a pilot reactor segment because it is maintained hot as much as possible by insulation and stratification. For example, being at the top of the reactor vessel heat from the segments below rises up to keep the pilot segment hot. By keeping the pilot segment hot the reaction can be restarted quickly with minimal external heating.

The segments in the reactor vessel may be turned on and off to achieve different overall generation rates. For example, with the pilot or first segment only operating a minimum generation rate may be achieved. Turning on the second segment, such as by increasing the synthesis gas flow into the first segment and/or starting synthesis gas flow in to the first quench inlet, will increase the generation rate. Additionally turning on the third segment will push the generation rate towards a maximum generation rate. When only the pilot or first segment is operating the heat from that segment is used to keep the subsequent segments warm so that they can be rapidly brought into generation to increase the generation rate. This heating is provided by the hot gases from the first segment flowing down and through the second and third segments.

FIG. 15 is a piping and instrumentation diagram of a reactor according to the present invention. The diagram is similar to that of FIG. 3a. The items shown in FIG. 15 may replace items to the right of the line “A” in FIG. 3a. That is, the reactor vessel and associated items shown in FIG. 15 may replace the reactor modules 230, 240, and associated items shown in FIG. 3a.

Similarly to FIG. 3a, gases leaving the reactor vessel or reactor modules may be passed through a heat exchanger for extracting some of the heat in those gases. The extracted heat may be used to heat up the synthesis gas flowing to the reactor vessel. In FIG. 3a the heat exchanger performing this heat exchange process is heat exchanger 220 and in FIG. 15 the heat exchanger performing this process is heat exchanger 615. In both cases this heat exchanger may be considered to be the primary heat exchanger. In FIG. 15 the primary heat exchanger may be co-located in the insulation 504 surrounding the reactor vessel. By locating the primary heat-exchanger close to the reactor vessel, less heat is lost in piping between the heat exchanger and the reactor vessel thereby improving efficiency and reducing energy loss.

Turning in more detail to FIG. 15, the primary heat exchanger 615 has an inlet or pre-reaction side (which is the left hand side in the figure) and an outlet or post-reaction side (which is the right hand side in the figure. The inlet side of the heat exchanger is arranged to receive synthesis gas, such as from the nitrogen and hydrogen sources or from a syngas buffer tank. The supply of synthesis gas is controlled by mass flow controller 642. When mass flow controller 642 is turned on the synthesis gas flows through piping to the inlet side of the primary heat exchanger 615. The inlet side of the primary heat exchanger is also connected by piping 530 to the first inlet of the reactor vessel 502. The synthesis gases flow through the reactor vessel and are, at least partly, converted to ammonia gas product in the reactor vessel.

On the flow path to the primary heat exchanger the synthesis gas is divided at 606 to tap off some of the synthesis gas for supply to the second inlets or quench inlets 508, 510, of the reactor vessel. At 608 the flow is divided into separate flows for each of the second or quench inlets. Mass flow controllers 646 and 644 respectively control the flow of synthesis gas to quench inlet 1, 508, to supply synthesis gas between the first and second segments and to the quench inlet 2, 510, to supply synthesis gas between the second and third segments.

The reactor vessel 502 has an outlet or exit port such as outlet 524 at the base of the vessel and connected to base region 522 of the reactor. This outlet may be connected to outlet side of the primary heat exchanger 615 to transfer heat to the synthesis gas flowing through the inlet side of the heat exchanger to the first inlet at the top of the reactor vessel. After flowing through the primary heat exchanger 615 the output gas flows along piping 610 to the gas separator and chiller as shown in FIG. 3a (not shown in FIG. 15). The output gas will be a mix of unreacted synthesis gas and ammonia gas product. Before separation of the ammonia from the synthesis gas the mixture has further heat removed by a heat exchanger 280 and is then further cooled by heat exchanger 285 connected to chiller 290 which liquifies the ammonia. The liquid ammonia is separated at separator 295 and may be stored in a tank. The separated synthesis gas is recycled back to the reactor vessel for reaction after combining with more nitrogen and hydrogen.

The outlet 524 from the base region of the reactor vessel 502 is shown differently in FIG. 15 compared to FIG. 14. In FIG. 15 there are two exit ports or outlets from the base region 522. One of outlet comprises piping passing up through the reactor vessel towards the top of the reactor vessel where piping 532 directs the flow outside the reactor vessel and down through piping 624 to the primary heat exchanger outlet side. This arrangement flows the hot gases from the base of the reactor vessel to the top to transfer heat to the synthesis gas in further up the vessel. The other outlet or exit port is directly out of the base of the reactor vessel in the same way as FIG. 14.

The primary heat exchanger 615 may also comprise an auxiliary heater such as an electric heater to heat the synthesis gas flowing from piping 602 to the first inlet 506 of the vessel 502. The auxiliary heater may be similar to auxiliary heater 215 in FIG. 3a and may be used on start-up to bring the synthesis gas up to a minimum generation temperature, such as may be required for the catalyst to work effectively.

Also shown in FIG. 15 are forward bypass 630 and reverse bypass 622. Forward and reverse bypasses may be selectively opened to bypass the primary heat exchanger in the forward and reverse directions. Forward bypass 630 is connected to input flow piping 602 at 631 and bypasses primary heat exchanger joining by piping 530 connecting to first inlet of the reactor vessel. Mass flow controller 632 on the forward bypass controls 630 the flow of synthesis gas through the bypass. By bypassing the primary heat exchanger the synthesis gas may not be heated as much and the temperature of synthesis gas at the first inlet 506 and at the first reactor segment may be lowered. The reverse bypass 622 is connected to the base region of the reactor vessel bypassing the primary heat exchanger and connects to mass flow controller 648 which controls the flow of gas through the reverse bypass. Reverse bypass further connects to second heat exchanger 660, which is a heat exchanger for supplying heat to a thermal store. After passing through thermal store heat exchanger 660 the piping is arranged to join the output gases returning to the separator. Accordingly, the heat of the output gases from the reactor vessel may be used to: i) heat up the synthesis gas flowing to the reactor vessel; and/or ii) provide heat to a thermal store.

In the embodiment of FIG. 15 in which some output gases are flowed up back up through the reactor vessel, turning on the reverse bypass 624 will lower the temperature in the reactor vessel because some of the hot output gases will no longer be heating the reactor vessel and will instead be flowing to thermal store heat exchanger.

Thermal store 650 is shown FIG. 15 and is connected in a loop to the thermal store heat exchanger by piping 665. Circulator 670 is arranged on the loop to pump heat transfer fluid around the loop to transfer heat from the heat exchanger 660 to the thermal heat store 650. The heat transfer fluid may be an inert gas. The heat transfer fluid is pumped to the thermal store such that it arrives at the hot end (top) of the thermal store first, so as to maximise the high temperature of the store. The heat stored in the thermal store may be used for various external processes. For example, as described for the preceding embodiments the heat may be used elsewhere such as to drive a small steam turbine or a compressed air driven generator. Alternatively, the heat from the thermal store may be used to regenerate an ammonia absorber, such as MgCl₂.

Also shown in FIG. 15 are various temperature and pressure sensors for measuring the temperature and pressure at various points in the reactor. For example, T2, T3 and T4 respectively sense the temperature at the bottom, middle and top of primary heat exchanger. T5 to T11 sense temperatures at the reactor vessel, as follows:
T5—temperature at first (main) inlet to reactor vessel;
T6 and T7—temperature at top and bottom of first reactor segment;
T8 and T9—temperature at top and bottom of second reactor segment; and
T10 and T11—temperature at top and bottom of third reactor segment.

Other temperatures and pressures that are sensed include:
T12—temperature of output gases after passing through primary heat exchanger;
T13—temperature of output gases after passing through thermal store heat exchanger;
T14—temperature of output gases heading to separator; and
P3—pressure of output gases heading to separator.
   Additional pressures and temperatures sensed which are not shown in FIG. 15 include the temperature and pressure of the synthesis gas as it leaves a buffer and/or supply, and various temperatures and pressures around the separator piping circuit.

The controller 599 shown in FIG. 15 may use any of the sensed temperatures and pressures in determining the operating conditions and setting the control of the reactor. For example, if the reactor vessel is to be operated at a minimum production rate then synthesis gas may be supplied to the first inlet to the reactor vessel only and temperatures monitored in the first reactor segment. Monitoring the temperature in the first reactor segment is desirable to check that the temperature remains in the operating temperature range for the catalyst. If the temperature starts to become too high such that the efficiency of the catalyst begins to be reduced, the controller can send a signal to the mass flow controller 632 to open the forward bypass such that the synthesis gas entering the reactor vessel is not heated as much. The controller may also, or instead, send a signal to the mass flow controller 644 to open the reverse bypass to further reduce the temperature in the reactor vessel. This is achieved by flowing less hot outlet gases back through the reactor vessel and flowing some of the outlet gases directly out the base of the reactor vessel.

If it is desired to increase the production rate the controller may open mass flow controllers 644 and 646 to start flow of synthesis gas into the quench inlets 508 and 510. The controller 599 can monitor the temperatures in the second and third reactor segments and adjust quench inlet flow rates to keep the temperatures in the second and third reactor segments in the working range for the catalyst. The controller can also open and close the forward and reverse bypasses to adjust the input temperature of the synthesis gas to the first inlet and the amount of heating the through the reactor vessel the gases flowing up through the reactor vessel provide.

The reactor of FIG. 15 has a reduced number of flow control valves and a reduced number of high temperatures flow control valves compared to the reactor of FIG. 3. This aims to increase the reliability. The reactor of FIG. 15 also has fewer welded joints between components compared to previous designs because a single vessel houses all reactor segments. Progressive employment of reactor segments avoids switching off flows.

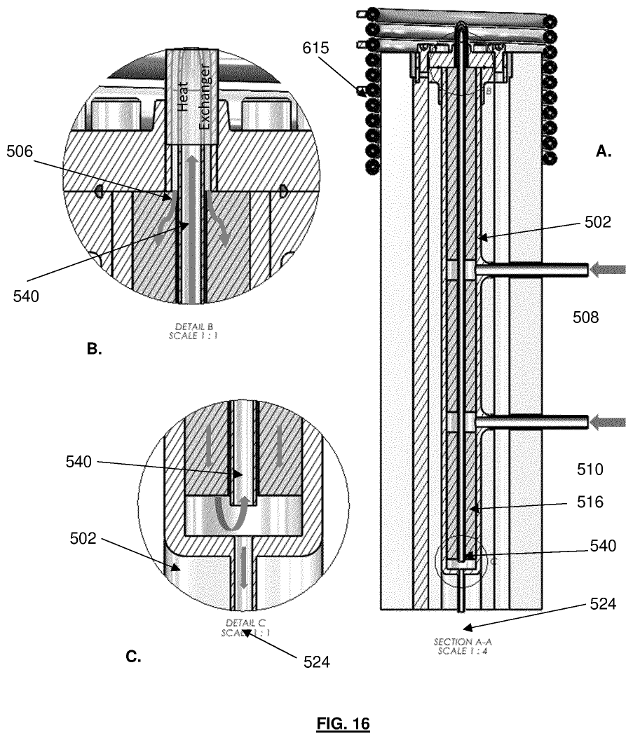

FIG. 16 shows more detail of the reactor vessel 502 shown in FIG. 15 in which a flow tube passes internally through the vessel taking ammonia gas and synthesis gas from the base of the reactor up and out through the top of the reactor vessel. The purpose of this flow tube is that the ammonia gas and synthesis gas from the bottom of the reactor are hot and the heat can be used to heat up the synthesis gas entering the vessel. FIG. 16A is a cross-section of the heat exchanger vessel including insulation and other components. FIGS. 16B and 16C are detail views of the connection of the flow tube to the primary heat exchanger and at the base of the vessel respectively. In FIG. 16 the reactor vessel is again indicated by reference number 502 and second inlets 508 and 510 can be seen. At the top of the reactor vessel is primary heat exchanger 615. The primary heat exchanger is schematically shown located differently in FIG. 15 but it is preferable that the primary heat exchanger 615 is located close to the first/pilot segment of the reactor vessel such that heat loss is minimized in keeping the first/pilot segment hot. In FIG. 16 the third reactor segment is again indicated by 516. The other reactor segments can be seen. Flow tube from the base region of the reactor vessel to the top is indicated by 540. Below the third rector segment is base region which is a space where the synthesis gas and ammonia gas product can flow to outlet 524. Also in this base region space is the start of flow tube 540 which carries the ammonia gas and synthesis gas up through the reactor segments. The reactor segments may be warmed by the gases in this flow tube. Preferably, the flow tube is arranged through the centre of the reactor segments. In FIG. 16B the main inlet for synthesis gas into the reactor vessel can be seen, with downward arrows indicating the flow of synthesis gas into the first/pilot segment. The upward arrow indicates flow of ammonia gas and synthesis gas up through the flow tube 540 towards the primary heat exchanger which is indicated by the grey shaded portion. FIG. 16C shows the base region of the reactor vessel 502 with the gases flowing down through the third or final segment and into the base region. The gases here may divide with some of the gases flowing out of the outlet 524 and some of the gases flowing up through the flow tube 540.

In alternative embodiments the flow tube 540 to the primary heat exchanger may be outside of the reactor vessel. The reactor vessel may also include other numbers of reactor segments and may take different shapes.

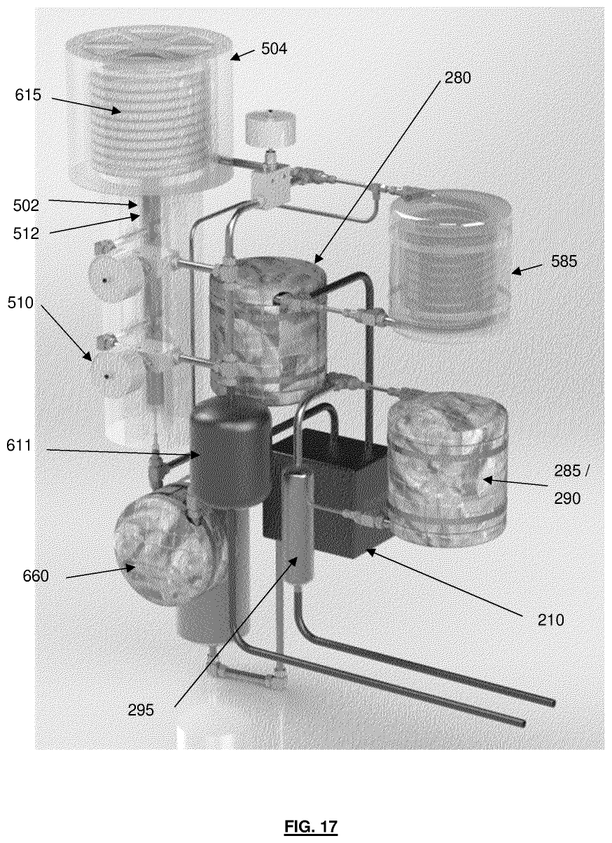

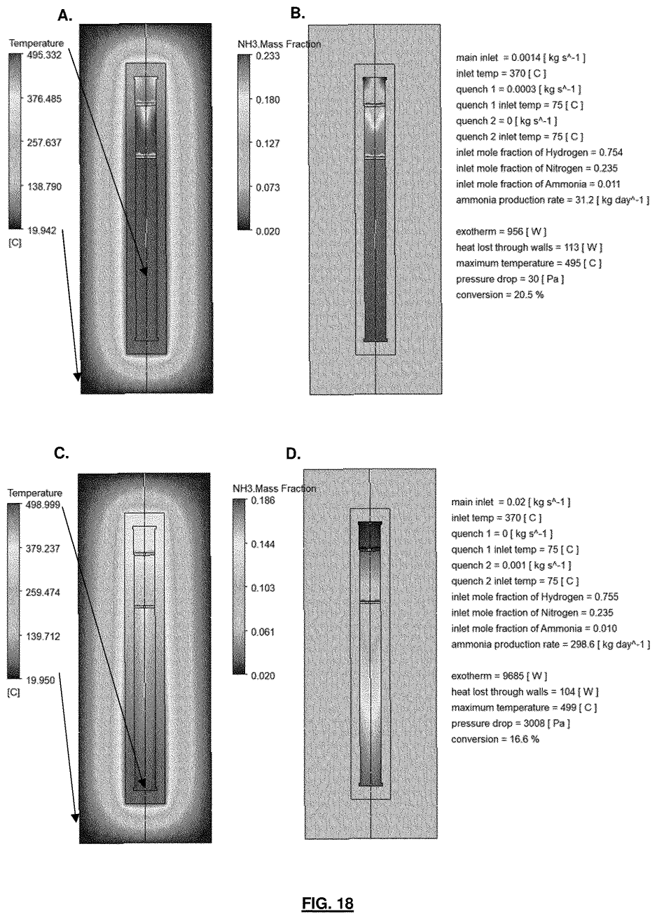

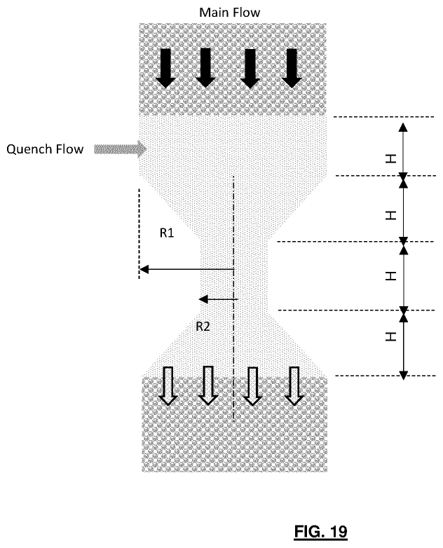

FIG. 17 is a diagram from a 3D CAD model of a reactor according to embodiments of the present invention. Various elements from FIGS. 3a, 15 and 16 are shown combined into the reactor of FIG. 17. The reactor vessel 502 with reactor segments is shown on the left hand side. On top of the reactor vessel is the primary heat exchanger 615 which comprises coiled piping with inner and outer or core and shell piping running in the coiled loops. The inner and outer pipes contain synthesis gas flowing to the reactor vessel and output gasses flowing from the output end or based region of the reactor. The output gases from the reactor flow in the inner pipe to heat the input gases flowing in the outer pipe. Primary heat exchanger 615 is surrounded in insulation which may be microporous insulation. Following output from the reactor vessel, output gases flow to heat exchanger 660 which is high grade heat exchanger for supplying heat to the thermal store 650. A series of further heat exchangers 280, 285 and a chiller 290 cools the output gases further such that the ammonia liquifies and can then be separated by separator 295. The cooled synthesis gas can be recycled and combined with new hydrogen and nitrogen gas and input back to the system. A buffer vessel 611 may be provided which regulates and stores a supply of synthesis gas. Compressor 210 pumps synthesis gas from the buffer vessel to the primary heat exchanger for further reaction.

FIG. 18 are plots showing the temperature and mass fraction ammonia at 10% generation rate and full generation rate. FIGS. 18A and 18B are respectively the temperature and mass fraction ammonia at 10% generation rate and FIGS. 18C and 18D are respectively the temperature and mass fraction ammonia at full generation rate. The plots include the reactor vessel, reactor segments and insulation. For the 10% generation rate the synthesis gas is mostly input through the first/main inlet with a small amount (<15%) through the upper of the two quench/second inlets, whereas for higher generation rates it may be input through the first and both second/quench inlets.

In FIG. 18A the highest temperature of around 450-495° C. is achieved through much of the reactor vessel from below the mixing zone between the first and second reactor segments. FIG. 18B shows that the mass fraction of ammonia recaches its maximum at around half way down the second reactor segment. These plots indicate that at the lower generation rate most of the reaction is occurring in the first and second reactor segments. The small amount of synthesis gas added at the first quench inlet cools the gas temperature a small amount and the reaction temperature increases in the middle reactor segment and the mass fraction ammonia also reaches its maximum in the second reactor segment. The lower segments are kept warm by the hot gases flowing through them.

In FIG. 18C for full generation rate the temperature in the reactor vessel can be seen to be steadily increasing as the synthesis gas flows down through the vessel. A small amount of cooling can be seen at each of the mixing zones where small amounts of synthesis gas are added at the quench inlets. FIG. 18D shows that the mass fraction ammonia is also steadily increasing going down through the vessel. This shows the reaction is spread out through all of the segments of the reactor vessel. The addition of synthesis gas which is cooler than the gases already in the reactor vessel helps keep the temperature within an operating range of the catalyst. Without the quench inlets the temperature would exceed the high end of the optimum operating temperature range of the catalyst. The cooling caused by quench inlets may result in the temperature profile down the reactor vessel having a saw-tooth form.

To avoid hot and cold spots close to the mixing zones it is important that synthesis gas entering through the quench inlets mixes thoroughly with the gas already in the reactor vessel. FIG. 19 shows a mixing zone configuration that improves the uniformity of mixing between the quench flow and main flow. The mixing zone also takes up minimal space with minimum induced pressure drop. Any pressure drop through the reactor has to be overcome by the recycle compressor and the greater the resistance to flow through the reactor the greater the auxiliary power consumption. The improved mixing zone comprises a narrowed section of the inside of the reactor vessel immediately following quench inlet. As shown in FIG. 19 the width of the vessel narrows from a full width of circular cross-section and radius R1, to a reduced width section of radius R2. In one example, R2 may be a quarter of the dimension of R1. Hence, the cross-sectional area of the narrowed section may be less than 1/10^{th} of the area of the full section, such as 1/16^{th} of the area. The mixing zone narrows from the full width to the narrowed width through a conical section and opens back up to the full width cross-section with an inverted conical section. In one embodiment each of the narrowed section, the conical section and the inverted conical section may take up approximately equal heights in the reactor column. Each of these heights is shown as height H in FIG. 19. The quench inlet may be located in a full width part of the mixing zone above the narrowed sections, for example, the height of which may also be of height H. In one example demonstrator embodiment, the dimensions R1 and R2 may be 0.04 m and 0.01 m, and the height H may be 0.02 m. The mixing zone of FIG. 19 provides improved mixing at minimum and full generation rates.

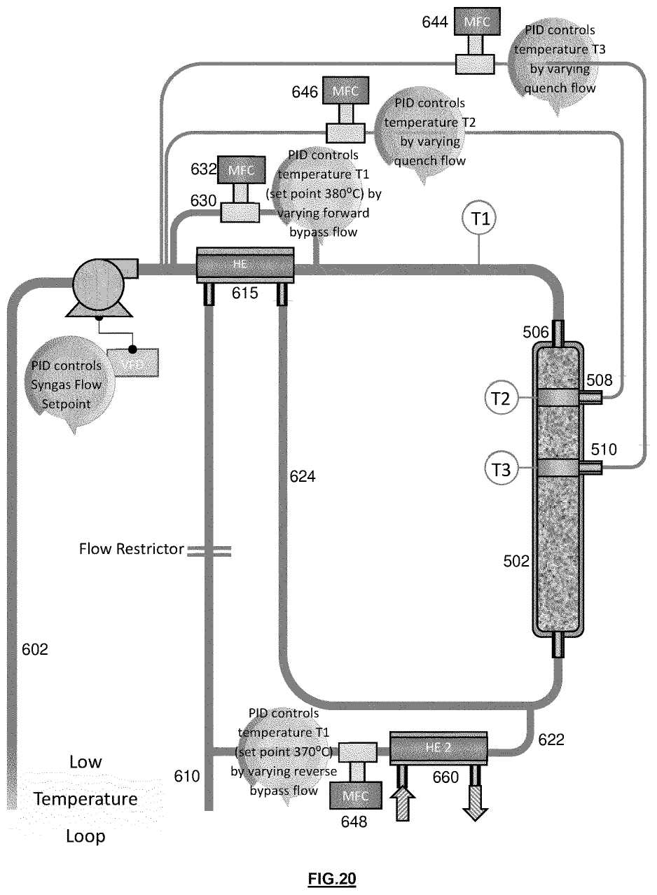

FIGS. 20-23 are flow diagrams explaining the operation logic of the reactor and overall energy storage system.

FIG. 20 is a schematic piping diagram showing the control strategy of the heat exchangers and bypasses. The two bypasses 622 and 630 are used to manage the inlet temperature T1 to the reactor vessel. The numbering and piping layout in FIG. 20 mirrors that of FIG. 15. In one embodiment, the optimal inlet temperature for the synthesis gas into the main/first inlet of the reactor vessel is 370° C. In FIG. 20 the synthesis gas flows from source, or syngas buffer, along flow pipe 602. Variable flow device, VFD, in FIG. 20 is controlled by a controller to set the synthesis gas flow rate to a desired setpoint. The controller may be of a PID (proportional-integral-derivative) type. The VFD device may correspond to the mass flow controller 642 in FIG. 15. The input synthesis gas may next flows through primary heat exchanger 615 to reactor vessel 502. After partial reaction in the reactor vessel the mixed ammonia and synthesis gas flows from the outlet 624 back to the primary heat exchanger, but now flows through the hot-side of the heat exchanger exchanging heat with the heat exchanger. From the primary heat exchanger 615 the mixed gas flows back 610 to the gas separator and chiller, as previously described. Reverse bypass 622 is opened and flow through it is set by mass flow controller 648. Opening the reverse bypass is used to supply high grade heat from the second heat exchanger 660 to the thermal store. The reverse bypass can reduce the flow of hot gases through the primary heat exchanger to maintain the synthesis gas inlet temperature at the desired temperature, such as the 370° C. mentioned above. The thermal mass in the walls of the primary heat exchanger may make the primary heat exchanger slow to remove heat from the output gases coming from the reactor vessel. By opening the reverse bypass 622 more heat may be removed from the output gases than by the primary heat exchanger alone. The reverse bypass may be used to tap-off a fraction, such as 5%, 10%, 20%, or up to around 50%, of the output gases leaving the reactor to direct it through the second heat exchanger for supplying heat to the thermal store for storing high grade heat. A flow restrictor may be included in the flow path from the primary heat exchanger back to the gas separator and chiller. The flow restrictor may be provided to encourage flow through the thermal store heat exchanger 660. The forward bypass 630 provides an alternative method for controlling the inlet temperature, by bypassing the heating from the primary heat exchanger. Flow through the forward bypass is set by mass flow controller 632. The target temperature for the flow through the forward bypass opening may be set higher than the reverse bypass by 5-10° C. such that the forward bypass only opens if the reverse bypass is ineffective in raising or reducing temperature. For example, the forward bypass may be opened if the reactor inlet temperature becomes too high and there is a need for a fast response reduction in inlet temperature. It is preferred to use the reverse bypass but this does not respond as quickly. Hence, the forward bypass is included to provided system robustness and safety but may not be required if the reverse bypass is always effective in controlling inlet temperature. The reverse bypass helps with system efficiency by providing heating to the inlet gases that might otherwise require electrical heating.

FIG. 20 also shows that the controller, such as PID controller, controls the temperatures T2 and T3 at the mixing zones in the reactor by varying the flow into the quench ports 508, 510. The flows are varied by mass flow controllers 644 and 646.

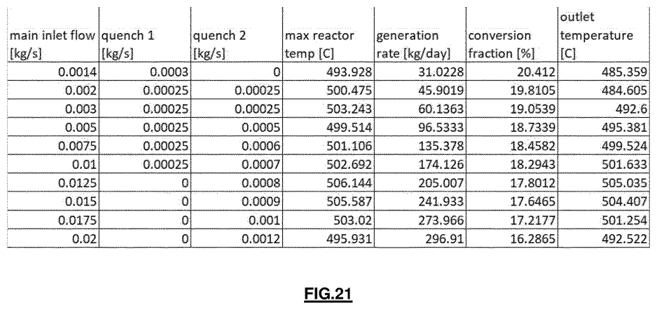

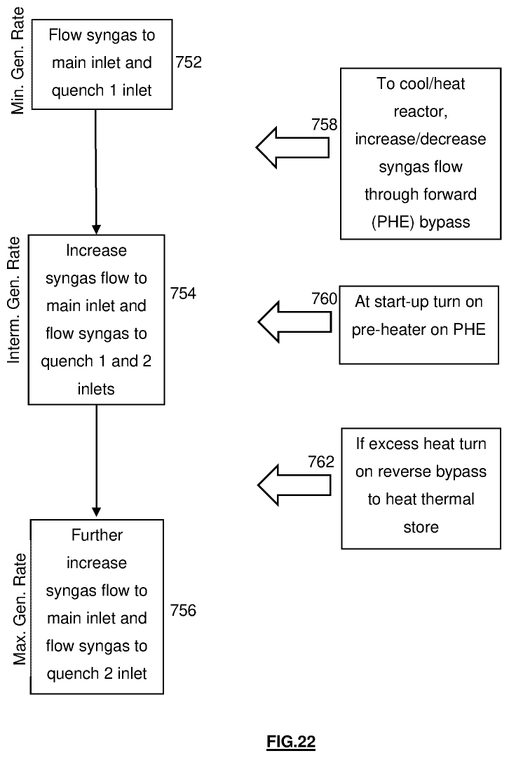

FIG. 21 is a table of example flow rates of synthesis gas through the main inlet, first quench inlet and second quench inlet, along with reaction rates and temperatures. FIG. 22 is a flow chart showing how the various generation rates are linked to the flow rates.

In the table of FIG. 21 the minimum inlet flow rate is shown as 0.0014 Kg/s. This provides an ammonia generation rate of 31.0228 kg/s. There is a small flow of synthesis gas into the first quench inlet to prevent the maximum temperature in the reactor exceeding 500-510 C. This minimum ammonia generation rate is indicated at 752 in FIG. 22. At an intermediate generation rate 754 synthesis gas flow is increased in the first quench and the second quench inlets. For example, at an intermediate ammonia generation rate of 177.126 kg/s the main inlet flow rate is increased to 0.01 kg/s and small flows are provided to the first quench inlet and the second quench inlet. At the higher ammonia generation rates no flow is required to the first quench inlet. At the highest ammonia generation rate of 296.91 kg/s (nearly 10× the minimum generation rate), the main inlet flow rate is 0.02 kg/s and a small flow to the second quench inlet is provided. The maximum generation rate is shown at 756 in FIG. 22. In all cases the maximum reactor temperature does not exceed around 510 C.

The first and second quench flows may be adaptively controlled to keep the temperature distribution in the reactor at the desired values. The temperature of inlet gases may be controlled by turning on the first and second bypasses. The first bypass may be used to control 758 the inlet temperature and the second bypass may be used to remove heat 762 from the reactor to the thermal store. As shown in FIG. 22 at 760, preheater may be used at startup to heat the inlet gases or may be used at other times to add heat to the reactor system.

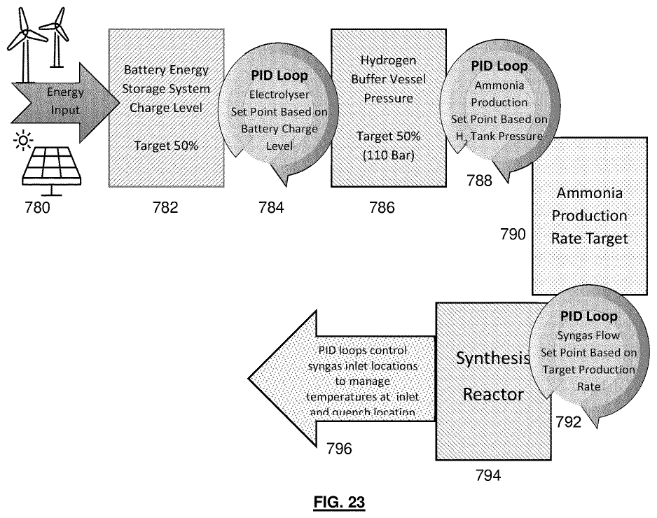

FIG. 23 shows the overall control strategy for a flexible ammonia synthesis plant, such as including a reactor as described herein and other energy storage systems. In a first step at 780 energy is generated from intermittent renewable energy sources, such as wind and solar. When the energy is plentiful or there is excess energy it may be used to charge 782 a battery energy storage system. The energy stored in the battery system may be supplied to an electrolyser to produce hydrogen. The battery acts as a buffer and is not expected to store large amounts of energy to power the electrolyser or ammonia plant for any length of time. Instead, the battery facilitates islanded operation from an off-grid intermittent power source by buffering differences between the renewable supply and plant demand. The target for the battery storage is to maintain the charge level at around 50%. This enables some discharge or charging from the nominal set point in the event that there is either a surplus or a deficit of renewable energy compared to the plant demand. The hydrogen produced from electrolysis is supplied to a hydrogen buffer pressure vessel at 786. The electrolyser operating point is set or controlled based on the battery charge level. The electrolyser is the largest user of energy of the green ammonia synthesis plant and is rapid in response. For example, the load drawn by the electrolyser can be changed in the order of a second. It is this rapid response that enables us to track an intermittent renewable power source accurately and hence only require a small amount of battery energy storage. The hydrogen produced by the electrolyser is supplied to a pressure vessel. The pressure vessel acts as a buffer and is targeted to 50% of capacity. A 50% set point allows hydrogen to either be accumulated or used following fluctuations in ammonia plant demand compared to available power for electrolysis. That said, the battery and the hydrogen store are relatively small buffers because the ammonia plant generation is flexed inline with the available input power and is the main use or sink for the energy generated. Hence, the need for expensive battery and hydrogen storage is minimized. In FIG. 23, at 788 the ammonia generation rate is set based on the pressure in the hydrogen pressure vessel. The generation rate determined 790 is used to control the synthesis gas flow into the reactor and the operating conditions such as temperature and quench flows of the reactor at 794, 796. The generated ammonia can be stored and used for energy production, fertilizer production or various other uses.

Although specific embodiments of the invention have been described with reference to the drawings, the skilled person will be aware that variations and modifications may be applied to these embodiments without departing from the scope of the invention defined in the claims. For example, different numbers of reactor modules may be provided and different sizes of reactor tubing may be used. The arrangements of piping and valves used may also be different. The techniques described herein, such as using heat from an exothermic reaction in a reactor module to heat a heat store or other reactor module, may be applied to exothermic reactions other than ammonia production.

Embodiments of the present invention are provided in the following clauses:
Clause A1. A reactor for generating ammonia from a synthesis gas by an exothermic reaction, comprising:
a plurality of reactor modules each comprising a reaction volume which contains a catalyst for the exothermic reaction and which is arranged to a receive the synthesis gas, and a heat transfer volume arranged to receive heat transfer fluid for delivering heat to or receiving heat from the reaction volume, each reactor module arranged to be in a production state in which the ammonia is being generated or an idle state in which it is not being generated;
a heat store coupled to each of the reactor modules so as to controllably receive the heat transfer fluid from, or deliver the heat transfer fluid to, any of the reactor modules; and
a control system arranged to selectively transfer heat, by controlled flow of the heat transfer fluid, from one or more of the reactor modules which are in the production state, to the heat store, and to selectively transfer heat, by controlled flow of the heat transfer fluid, from the heat store, to one or more of the reactor modules which are in the idle state.
Clause A2. The reactor of clause A1 wherein the control system is arranged to selectively transfer heat, by controlled flow of the heat transfer fluid, from one or more of the reactor modules which are in the production state, directly to one or more of the reactor modules which are in the idle state.
Clause A3. The reactor of clause A1 or A2 wherein at least a portion of the reaction volume must be at, or above, a minimum production temperature for a reactor module to be in the production state, and the control system is arranged to maintain one or more, or all, of the reactor modules which are in the idle state at or above the minimum production temperature by transfer of heat using the heat transfer fluid, from the heat store and/or from one or more of the reaction modules which are in the production state.
Clause A4. The reactor of clause A3 wherein each reactor module is arranged to be in a shutdown state if not in a production state and not in an idle state, the shutdown state where all of the said reaction volume is below the minimum production temperature, the control system is arranged to raise the temperature of at least a portion of said reaction volume to at least the minimum production temperature using the heat transfer fluid to transfer heat from the heat store or from one or more other ones of the reaction modules which are in the production state.
Clause A5. The reactor of any preceding clause wherein the control system is arranged to transition any of the reactor modules from the idle state to the production state, including by introducing a production flow of the synthesis gas through, or into, the reaction volume of the reactor module in the idle state.
Clause A6. The reactor of any preceding clause wherein the control system is arranged to control the flow of heat transfer fluid such that if one or more of the reactor modules are in the production state, the heat transfer fluid from the one or more reactor modules is directed to supply heat to the heat store.
Clause A7. The reactor of any preceding clause further comprising a separator arranged to receive the synthesis gas following flow through at least the reactor modules currently in the production state, to separate ammonia from the received synthesis gas, and to return the synthesis gas to at least the reactor modules currently in the production state.
Clause A8. The reactor of clause A7 comprising a recuperative heat exchanger arranged to transfer heat from the synthesis gas flowing from the reactor modules to the separator, to the synthesis gas flowing from the separator to the reactor modules.
Clause A9. The reactor of any preceding clause arranged to maintain the reaction volume of each reactor module above a minimum reaction pressure, and to maintain the heat transfer volume of each reactor module below a maximum heat transfer fluid pressure, wherein the minimum reaction pressure is at least twice the maximum heat transfer fluid pressure.
Clause A10. The reactor of clause A9 wherein the minimum reaction pressure is at least 20 bar, or at least 50 bar, and the maximum heat transfer fluid pressure is no more than 10 bar, or no more than 2 bar.
Clause A11. The reactor of any preceding clause wherein the reaction volume of each reactor module is defined by a plurality of reaction tubes each containing said catalyst and arranged to carry in parallel synthesis gas flowing through the reaction volume.
Clause A12. The reactor of any preceding clause wherein the heat transfer volume of each reactor module is defined by a vessel containing the reaction volume.
Clause A13. The reactor of clause A12 wherein each of the reactor modules has a minimum and a maximum rate of generation of the ammonia when in the production state, and the maximum rate of ammonia generation of a smaller one of the reactor modules exceeds the minimum rate of ammonia generation of a larger one of the production modules.
Clause A14. The reactor of any preceding clause wherein the ratio of maximum to minimum rate of generation of the ammonia, of each of the reactor modules, is no more than ten, or no more than five
Clause A15. The reactor of any preceding clause wherein the controller is arranged to direct the heat transfer fluid through each reactor module only in the same direction as the flow of synthesis gas through the reactor module.
Clause A16. The reactor of any preceding clause wherein the heat store is a stratified heat store having a hot end into which heat from the reactor modules is directed using the heat transfer fluid, and from which heat from the heat store is directed to the reactor modules using the heat transfer fluid.
Clause A17. The reactor of any preceding clause further comprising an excess heat exchanger arranged to remove heat from the heat transfer fluid if the heat stored in the energy store and/or in the heat transfer fluid exceeds an excess threshold.
Clause A18. The reactor of any preceding clause further comprising a regenerative ammonia absorber, such as MgCl₂, arranged to receive heat from the heat store or from the heat transfer fluid to regenerate the ammonia absorber.
Clause A19. The reactor of any preceding clause wherein the synthesis gas comprises hydrogen and nitrogen.
Clause B20. An energy storage system comprising:
one or more intermittent sources of renewable energy;
an electrolysis unit for producing hydrogen using the renewable energy; and
the reactor of any of preceding clause arranged to generate ammonia from the produced hydrogen.
Clause B21. The energy storage system of clause B20 wherein the one or more intermittent sources of renewable energy comprising one or more wind turbines, and/or one or more solar panels.
Clause C22. A method of generating ammonia from a synthesis gas by an exothermic reaction, the method comprising:
flowing the synthesis gas through, or into, a reaction volume of one or more reactor modules, the reaction volume containing a catalyst for the exothermic reaction;
flowing a heat transfer fluid through a heat transfer volume of the one or more reactor modules and through a heat store; and
selectively transferring heat, by controlled flow of the heat transfer fluid, from one or more of the reactor modules which are in a production state in which ammonia is being generated, to the heat store, and selectively transferring heat, by controlled flow of the heat transfer fluid, from the heat store, to one or more of the reactor modules which are in an idle state in which ammonia is not being produced.
Clause C23. The method of clause C22 further comprising selectively transferring heat, by controlled flow of the heat transfer fluid, from one or more of the reactor modules which are in the production state, directly to one or more of the reactor modules which are in the idle state.
Clause C24. The method of clause C22 or C23 further comprising maintaining one or more, or all, of the reactor modules which are in the idle state at or above a minimum production temperature by transfer of heat using the heat transfer fluid, from the heat store and/or from one or more of the reaction modules which are in the production state, wherein the minimum production temperature is the temperature for a reactor module to be in the production state.
Clause C25. The method of clause C24 further comprising raising the temperature of at least a portion of said reaction volume to at least the minimum production temperature using the heat transfer fluid to transfer heat from the heat store or from one or more other ones of the reaction modules which are in the production state.
Clause C26. The method of any of clauses C22 to C25 further comprising transitioning any of the reactor modules from the idle state to the production state, including by introducing a production flow of the synthesis gas through, or into, the reaction volume of the reactor module in the idle state.
Clause C27. The method of any of clauses C22 to C26 further comprising controlling the flow of heat transfer fluid such that if one or more of the reactor modules are in the production state, the heat transfer fluid from the one or more reactor modules is directed to supply heat to the heat store.
Clause C28. The method of any of clauses C22 to C27 further comprising separating, in a separator arranged to receive the synthesis gas following flow through at least the reactor modules currently in the production state, ammonia from the received synthesis gas, and returning the synthesis gas to at least the reactor modules currently in the production state.
Clause C29. The method of clause C28 further comprising transferring heat from the synthesis gas flowing from the reactor modules to the separator to the synthesis gas flowing from the separator to the reactor modules by a recuperative heat exchanger.
Clause C30. The method of any of clauses C22 to C29 wherein flowing the synthesis gas through, or into, the reaction volume of one or more reactor modules comprises flowing synthesis gas through a plurality of reaction tubes in parallel, each containing said catalyst.
Clause C31. The method of any of clauses C22 to C30 comprising direct the heat transfer fluid through each reactor module only in the same direction as the flow of synthesis gas through the reactor module.
Clause D32. A method of generating ammonia using one or more intermittent and/or variable output renewable energy sources comprising:
using a reactor to convert hydrogen generated using the renewable energy to ammonia, wherein the overall turndown ratio of the reactor is higher than the turndown ratio of each of a plurality of reactor modules comprised in the reactor; and
reducing a progression time to transfer any of the reactor modules from an idle state to a production state by recycling heat obtained from one or more of the reactor modules in the production state to one or more of the reactor modules in the idle state.
Clause D33. The method of clause D32 further comprising using a stratified heat store to store heat generated by one or more of the reaction modules when in the production state, and subsequently delivering the stored heat to one or more of the reaction modules when in the idle state.
Clause D34. The method of clause D32 or D33 wherein the intermittency and/or variability of the output of the one or more renewal energy sources is accommodated by the reduced progression time to transfer any of the reactor modules from an idle state to a production state.
Clause D35. The method of any of clauses D32 to D34 comprising reducing curtailment of the output or usage of the one or more intermittent and/or variable output renewable energy sources.

1. A reactor for generating ammonia from a synthesis gas by an exothermic reaction, comprising:
a reactor vessel having a first inlet and one or more second inlets for receiving the synthesis gas, the reactor vessel configured as a quench cooled reactor having a plurality of reactor segments, the one or more second inlets being quench inlets, the reactor vessel having a base region with one or more exit ports configured to output synthesis gas and ammonia gas received from the reactor segments;
a first heat exchanger coupled between the first inlet and the base region for transferring heat between the output gases and synthesis gas flowing to the first inlet;
a reverse bypass configured to receive output gases from one of the one or more exit ports and bypass the first heat exchanger; and
a control system configured to selectively control the flow of output gases through the first heat exchanger and reverse bypass.

2. The reactor of claim 1, wherein the control system is configured to selectively control the flow of output gases through the first heat exchanger and reverse bypass by opening the reverse bypass to increase heat removal from the output gases.

3. The reactor of claim 1, further comprising a second heat exchanger and a thermal store, the second heat exchanger is a thermal store heat exchanger configured to selectively receive output gases and transfer heat from the output gases to the thermal store via a heat transfer fluid.

4. The reactor of claim 3, wherein the second heat exchanger is connected to the reverse bypass to receive output gases when the control system selects flow through the reverse bypass.

5. The reactor of claim 3, wherein the thermal store is a stratified heat store having a hot end into which heat from the output gases is directed using the heat transfer fluid.

6. The reactor of claim 3, further comprising a regenerative ammonia absorber, such as MgCl2, arranged to receive heat from the thermal store to regenerate the ammonia absorber.

7. The reactor of claim 1, further comprising a forward bypass configured for receiving synthesis gas, bypassing the first heat exchanger and flowing the synthesis gas to the first inlet;

8. The reactor of claim 7, wherein the control system is configured to selectively control the flow of synthesis gas through the first heat exchanger and forward bypass to control the temperature of the synthesis gas at the first inlet.

9. The reactor of claim 1, wherein the plurality of reactor segments each comprise a reaction volume which contains a catalyst for the exothermic reaction, wherein the plurality of reactor segments are arranged sequentially such that the synthesis gas received at the first inlet flows through each of the plurality of reactor segments in turn, and the second inlets are arranged between reactor segments for supplying further synthesis gas for subsequent reactor segments.

10. The reactor of claim 9, wherein the control system is configured to control the amount of synthesis gas supplied to the quench inlets to control the temperature in the subsequent reactor segment.

11. The reactor of claim 1, wherein the reactor segments are sized with increasing reaction volumes from the first inlet.

12. The reactor of claim 11, comprising three or more reactor segments and wherein the first three of the three or more reactor segments have reaction volumes increasing in size in the ratios 1 to 2 to 5 or more, such as around 1:2:6 or 1:2:7.

13. The reactor of claim 11, wherein the control system is configured to control the flow of synthesis gas to the reactor segments to vary the ammonia generation rate between a minimum generation rate and a maximum generation rate and the ratio of minimum generation rate to maximum generation rate is 1:5 or more.

14. The reactor of claim 1, wherein the control system is configured to control the flow rate of synthesis gas into the first inlet and second inlets at the minimum generation rate such that the majority of the exothermic reaction in the reactor vessel occurs in a first reactor segment, the first reactor segment being the reactor segment having the smallest reaction volume of the reactor segments.

15. The reactor of claim 1, wherein the control system is further configured to control the flow rate of synthesis gas into the first inlet and second inlets at a reaction rate greater than the minimum generation rate such that the exothermic reaction occurs in reactor segments in addition to the first reactor segment.

16. The reactor of claim 1, wherein the control system is further configured to control the flow rate of synthesis gas into the first inlet and into the second inlets at the maximum generation rate such that the exothermic reaction is spread substantially through each of the plurality of reactor segments.

17. The reactor of claim 1, wherein the control system is further configured to stop the flow of synthesis gas into the first and second inlets in a pilot mode, and the reactor is arranged with a first reactor segment above subsequent reactor segments such that heat from second and subsequent reactor segments rises to maintain a minimum generation temperature in the first reactor segment.

18. The reactor of claim 1, wherein the reactor further comprises a flow tube passing inside the reactor vessel from the base region upwards through the reactor segments and configured to flow synthesis gas and ammonia therethrough, the flow tube coupled to the first heat exchanger to flow synthesis gas and ammonia gas from the base region to heat the first heat exchanger.

19. The reactor of claim 1, wherein the first heat exchanger comprises an auxiliary heater, such as an electrical heater, for heating synthesis gas passing to the first inlet.

20. The reactor of claim 1, wherein the reactor vessel and first heat exchanger are insulated by encasing together in a surrounding shell/enclosure of insulation.

21. The reactor of claim 1, wherein between adjacent reactor segments is a mixing zone for receiving synthesis gas flow from quench inlets and mixing the synthesis gas flow with flow of synthesis gas and ammonia gas from a preceding reactor segment, wherein the mixing zone comprises a neck portion having a narrower flow cross-section than the flow cross-section of the reactor segments.

22. The reactor of claim 1, wherein the efficacy of the catalyst in the first reactor segment is less than in other reactor segments.

23. The reactor of claim 1, wherein the synthesis gas comprises hydrogen and nitrogen.

24. An energy storage system comprising:
one or more intermittent sources of renewable energy;
an electrolysis unit for producing hydrogen using the renewable energy; and
a reactor of arranged to generate, by an exothermic reaction, ammonia from synthesis gas comprising the produced hydrogen, the reactor comprising:
a reactor vessel having a first inlet and one or more second inlets for receiving the synthesis gas, the reactor vessel configured as a quench cooled reactor having a plurality of reactor segments, the one or more second inlets being quench inlets, the reactor vessel having a base region with one or more exit ports configured to output synthesis gas and ammonia gas received from the reactor segments;
a first heat exchanger coupled between the first inlet and the base region for transferring heat between the output gases and synthesis gas flowing to the first inlet;
a reverse bypass configured to receive output gases from one of the one or more exit ports and bypass the first heat exchanger; and
a control system configured to selectively control the flow of output gases through the first heat exchanger and reverse bypass.

25. The energy storage system of claim 24 wherein the one or more intermittent sources of renewable energy comprise one or more wind turbines, and/or one or more solar panels.

26. A method of generating ammonia from a synthesis gas by an exothermic reaction, the method comprising:
flowing the synthesis gas into a first inlet of a reactor vessel to pass through a plurality of reactor segments to a base region of the reactor vessel, wherein in one or more of the reactor segments synthesis gas reacts exothermally to generate ammonia gas;
transferring heat, via a first heat exchanger, between the synthesis gas flowing to the first inlet and output gases comprising the ammonia gas and synthesis gas flowing from the base region, and
selectively opening a reverse bypass to receive a portion of output gases from the base region and bypass the first heat exchanger.

27. The method of claim 26, wherein selectively opening the reverse bypass increases heat removal from the output gases.

28. The method of claim 26, further comprising flowing the portion of output gases received from the base region through the reverse bypass to a second heat exchanger to transfer heat from the portion of output gases to a thermal store via a heat transfer fluid.

29. The method of claim 26, further comprising selectively opening a forward bypass for receiving a portion of synthesis gas, flowing the portion of synthesis gas through the forward bypass, bypassing the first heat exchanger and flowing the portion of synthesis gas to the first inlet.

30. The method of claim 29, wherein selectively opening a forward bypass and flowing a portion of synthesis gas therethrough controls or reduces the temperature of the synthesis gas at the first inlet.

31. The method of claim 26, wherein flowing the synthesis gas through a plurality of reactor segments comprises flowing the synthesis gas sequentially through a catalyst for the exothermic reaction in each of the plurality of reactor segments, and further comprising selectively supplying further synthesis gas to the reactor vessel at second inlets between reactor segments to control the temperature in subsequent reactor segments.

32. The method of claim 26, wherein the reactor segments are sized with increasing reaction volumes from the first inlet, and the method comprises controlling the flow of synthesis gas to the reactor segments to vary the ammonia generation rate between a minimum generation rate and a maximum generation rate, the minimum generation rate to maximum generation rate having a ratio of 1:5 or more.

33. The method of claim 26, further comprising controlling the flow rate of synthesis gas into the first inlet and second inlets at the minimum generation rate such that the majority of the exothermic reaction in the reactor vessel occurs in a first reactor segment, the first reactor segment having the smallest reaction volume.

34. The method of claim 26, further comprising controlling the flow rate of synthesis gas into the first inlet and second inlets at a reaction rate greater than the minimum generation rate such that the exothermic reaction occurs in reactor segments in addition to the first reactor segment.

35. The method of claim 26, further comprising controlling the flow rate of synthesis gas into the first inlet and second inlets at the maximum generation rate such that the exothermic reaction is spread substantially through each of the plurality of reactor segments.

36. The method of claim 26, further comprising stopping the flow of synthesis gas into the first and second inlets in a pilot mode, wherein the heat from second and subsequent reactor segments rises to maintain a minimum generation temperature in the first reactor segment.

37. The method of claim 26, further comprising mixing, at a mixing zone between adjacent reactor segments, a flow of synthesis gas received from a quench inlet with the flow of synthesis gas and ammonia gas from a preceding reactor segment.

38-65. (canceled)
